(19) United States
(12) Patent Application Publication
(10) Pub. No.: US 2025/0051179 A1
(43) Pub. Date: Feb. 13, 2025

(54) COMPOUNDS HAVING A THORTVEITITE-RELATED STRUCTURE AND METHODS FOR MAKING AND USING

(71) Applicant: Oregon State University, Corvallis, OR (US)

(72) Inventors: Munirpallam A. Subramanian, Philomath, OR (US); Jun Li, Decatur, GA (US); Yi-Chia Lin, Corvallis, OR (US)

(73) Assignee: Oregon State University, Corvallis, US (OR)

(21) Appl. No.: 18/929,145

(22) Filed: Oct. 28, 2024

Related U.S. Application Data
(63) Continuation of application No. PCT/US2023/020335, filed on Apr. 28, 2023.
(60) Provisional application No. 63/336,913, filed on Apr. 29, 2022.

(51) Int. Cl. C01G 31/00

(52) U.S. Cl. CPC C01G 31/006; C01P 2002/72; C01P 2002/82; C01P 2002/84; C01P 2006/42; C01P 2006/62; C01P 2006/63; C01P 2006/64

(57) ABSTRACT

Novel compounds having a thortveitite-related structure are disclosed. The compounds may be colored and may be useful as pigments. The compounds are durable with respect to an acid stability test that indicates that the pigments will not substantially change color when exposed to weak acids, such as rain. The compounds disclosed herein typically inexpensive to synthesize from earth-abundant, environmentally-friendly elements or minerals, and therefore are advantageous over existing pigments in the art.

### CROSS REFERENCE TO RELATED APPLICATION

This application is a continuation of PCT/US2023/20335, filed Apr. 28, 2023, which claims the benefit of the earlier filing date of U.S. Provisional Patent Application No. 63/336,913, filed Apr. 29, 2022, which are incorporated herein by reference in their entirety.

### ACKNOWLEDGMENT OF GOVERNMENT SUPPORT

This invention was made with government support under Directorate for Mathematical & Physical Sciences contract no. DMR-2025615 awarded by National Science Foundation. The government has certain rights in the invention.

### FIELD

This invention concerns compounds having a thortveitite structure, particularly colored compounds, compositions comprising the same, and a method for making and using the compounds and compositions.

### BACKGROUND

Currently used orange/red inorganic pigments mostly contain heavy metals like cadmium lead, and mercury, and consequently all suffer from environmental issues. There is a need for inorganic pigments, particularly intensely orange/red inorganic pigments, that are environmentally benign, earth-abundant and durable.

### SUMMARY

Disclosed herein are embodiments of a compound useful as a colored pigment but that does not contain toxic and/or environmentally problematic heavy metals. In some embodiments, the compound has a Formula I: Zn₂₋ₓNiₓV₂O₇ where x is from greater than 0.2 to 0.8, or x is from 1.2 to 1.8. In some embodiments, x is from greater than 0.2 to less than 0.5. The compound may have L*a*b* values of L* from 34 to 60, a* from 10 to 27, and b* from 19 to 60. In some embodiments, x is from greater than 0.2 to 0.8 and the compound has L*a*b values of L* from 34 to 51, a* from 17 to 27, and b* from 19 to 49. In other embodiments, x is from 1.2 to 1.8 and the compound has L*a*b values of L* from 51 to 60, a* from 10 to 14, and b* from 48 to 60. And/or the compound may be selected from Zn_{1.77}Ni_{0.23}V₂O₇, Zn_{1.76}Ni_{0.24}V₂O₇, Zn_{1.75}Ni_{0.25}V₂O₇, Zn_{1.7}Ni_{0.3}V₂O₇, Zn_{1.4}Ni_{0.6}V₂O₇, Zn_{1.2}Ni_{0.8}V₂O₇, Zn_{0.8}Ni_{1.2}V₂O₇, Zn_{0.6}Ni_{1.4}V₂O₇, Zn_{0.4}Ni_{1.6}V₂O₇, or Zn_{0.2}Ni_{1.8}V₂O₇.

Also disclosed herein are embodiments of a compound having a structure according to Formula II: Zn₂₋₂ₓMnₓMₓV₂O₇ where x is from greater than zero to 0.05; and M is Mg or Ni. The compound may have L*a*b* values of L* from 22 to 37, a* from 7 to 19, and b* from 3 to 22. In some embodiments, M is Mg, and the compound has L*a*b* values of L* from 32 to 36, a* from 10 to 19, and b* from 11 to 22. In other embodiments, M is Ni, and the compound has L*a*b* values of L* from 22 to 37, a* from 7 to 17, and b* from 3 to 17. And/or the compound may be selected from Zn_{1.98}Mn_{0.01}Mg_{0.01}V₂O₇, Zn_{1.96}Mn_{0.02}Mg_{0.02}V₂O₇, Zn_{1.94}Mn_{0.03}Mg_{0.03}V₂O₇, Zn_{1.92}Mn_{0.04}Mg_{0.04}V₂O₇, Zn_{1.96}Mn_{0.02}Ni_{0.02}V₂O₇, Zn_{1.96}Mn_{0.02}Ni_{0.02}V₂O₇, Zn_{1.94}Mn_{0.03}Ni_{0.03}V₂O₇, Zn_{1.92}Mn_{0.04}Ni_{0.04}V₂O₇, or Zn_{1.9}Mn_{0.08}Ni_{0.08}V₂O₇.

Compounds having a structure according to Formula III: In₂₋ₓZnₓGe₂₋ₓVₓO₇ also are disclosed. With respect to Formula I, x is from greater than zero to less than 2, and may be 0.1, 0.3, 0.5, 1, 1.5, 1.7, 1.8, 1.90, 1.93, 1.94, 1.95, or 1.98. The compound may have L*a*b values of L* from 48 to 67, a* from −3 to 7, and b* from 26 to 56, and/or be selected from In_{1.9}Zn_{0.1}Ge_{1.9}V_{0.1}O₇, In_{1.7}Zn_{0.3}Ge_{1.7}V_{0.3}O₇, In_{1.8}Zn_{0.8}Ge_{1.8}V_{0.5}O₇, InZnGeVO₇, In_{0.8}Zn_{1.8}Ge_{0.8}V_{1.5}O₇, In_{0.3}Zn_{1.7}Ge_{0.3}V_{1.7}O₇, In_{0.2}Zn_{1.8}Ge_{0.2}V_{1.8}O₇, In_{0.1}Zn_{1.9}Ge_{0.1}V_{1.9}O₇, In_{0.07}Zn_{1.93}Ge_{0.07}V_{1.93}O₇, In_{0.06}Zn_{1.94}Ge_{0.06}V_{1.94}O₇, In_{0.08}Zn_{1.95}Ge_{0.05}V_{1.95}O₇, or In_{0.02}Zn_{1.98}Ge_{0.02}V_{1.98}O₇.

Also disclosed are embodiments of a compound having a structure according to Formula IV: InZn₁₋ₓNiₓGeVO₇, where x is from greater than zero to 1. x may be 0.1, 0.3, 0.5, 0.7, or 1. The compound may have L*a*b values of L* from 54 to 59, a* from 4 to 13, and b* from 43 to 46. And/or the compound may be selected from InZn_{0.9}Ni_{0.1}GeVO₇, InZn_{0.7}Ni_{0.3}GeVO₇, InZn_{0.8}Ni_{0.8}GeVO₇, InZn_{0.3}Ni_{0.7}GeVO₇, or InNiGeVO₇.

Alternatively, the compound may have a structure according to Formula V: In₁₋ₓMn-ₓZnGeVO₇ where x is from greater than 0 to less than 1. In some embodiments, the compound is In_{0.9}Mn_{0.1}ZnGeVO₇.

In other embodiments, the compound has a structure according to Formula VI: Zn_{1.77-x}Ni_{0.23}MₓV_{2-y}P_{y}O₇, where x is from zero to 0.1; y is from zero to 2; and M is Mg, Ca, (NaAl), (NaGa). (KAl), or (KGa). x may be 0 or 0.1, and/or y may be 0, 0.2, or 2. The compound may have L*a*b values of L* from 35 to 77, a* from −2 to 26, and b* from 23 to 37. And/or the compound may be selected from Zn_{1.67}Ni_{0.23}Mg_{0.1}V₂O₇, Zn_{1.67}Ni_{0.23}Ca_{0.1}V₂O₇, Zn_{1.67}Ni_{0.23}(NaAl)_{0.1}V₂O₇, Zn_{1.67}Ni_{0.23}(NaGa)_{0.1}V₂O₇, Zn_{1.67}Ni_{0.23}(KAl)_{0.1}V₂O₇, Zn_{1.67}Ni_{0.23}(KGa)_{0.1}V₂O₇, Zn_{1.77}Ni_{0.23}P₂O₇, Zn_{1.77}Ni_{0.23}V_{1.8}P_{0.2}O₇, Zn_{1.67}Ni_{0.23}Mg_{0.1}V_{1.8}P_{0.2}O₇, Zn_{1.67}Ni_{0.23}Ca_{0.1}V_{1.8}P_{0.2}O₇, Zn_{1.67}Ni_{0.23}(NaAl)_{0.1}V_{1.8}P_{0.2}O₇, Zn_{1.67}Ni_{0.23}(NaGa)_{0.1}V_{1.8}P_{0.2}O₇, Zn_{1.67}Ni_{0.23}(KAl)_{0.1}V_{1.8}P_{0.2}O₇, or Zn_{1.67}Ni_{0.23}(KGa)_{0.1}V_{1.8}P_{0.2}O₇.

Also disclosed herein are embodiments of a compound having a structure according to Formula VII: Zn_{1.8}Cu_{0.1}M_{0.1}V₂O₇, where M is Ni, Mn, Mg, or Ca. The compound may have L*a*b* values of L* from 40 to 59, a* from 1 to 16, and b* from 26 to 44. In some embodiments, the compound is selected from Zn_{1.8}Cu_{0.1}Ni_{0.1}V₂O₇, Zn_{1.8}Cu_{0.1}Mn_{0.1}V₂O₇, Zn_{1.8}Cu_{0.1}Mg_{0.1}V₂O₇, or Zn_{1.8}Cu_{0.1}Ca_{0.1}V₂O₇.

Further embodiments concern compounds having a structure according to Formula VIII: Zn_{1.9}Cu_{0.1}VₓP₂₋ₓO₇, where x is from zero to 1.8, and may be 0 or 1.8. The compound may have L*a*b* values of L* from 46 to 81, a* from −3 to 4, and b* from 2 to 28, and/or be selected from Zn_{1.9}Cu_{0.1}P₂O₇ or Zn_{1.9}Cu_{0.1}V_{1.8}P_{0.2}O₇.

Also disclosed are embodiments of a compound having a structure according to Formula IX: Zn_{2-x-y}MnₓM_{y}V_{2-z}P_{z}O₇. With respect to Formula IX, M is Ni, Mg, or Ca; x is from greater than zero to 0.5, and may be 0.02, 0.1, or 0.5; y is from zero to 0.1, and may be 0 or 0.1; and z is from zero to 1, and may be 0, 0.2, or 1. The compound may have L*a*b values of L* from 34 to 37, a* from 20 to 22, and b* from 23 to 24. And/or the compound may be selected from Zn_{1.88}Mn_{0.02}Ni_{0.1}V₂O₇, Zn_{1.88}Mn_{0.02}Mg_{0.1}V₂O₇, Zn_{1.88}Mn_{0.02}Ca_{0.1}V₂O₇, Zn_{1.98}Mn_{0.02}V_{1.8}P_{0.2}O₇, Zn_{1.88}Mn_{0.02}Ni_{0.1}V_{1.8}P_{0.2}O₇, Zn_{1.88}Mn_{0.02}Mg_{0.1}V_{1.8}P_{0.2}O₇, Zn_{1.88}Mn_{0.02}Ca_{0.1}V_{1.8}P_{0.2}O₇, Zn_{1.9}Mn_{0.1}VPO₇, Zn_{1.9}Mn_{0.1}V_{1.8}P_{0.2}O₇, Zn_{1.9}Mn_{0.1}V_{1.5}P_{0.5}O₇, or Zn_{1.5}Mn_{0.5}V_{1.5}P_{0.5}O₇.

Alternative compounds have a structure according to Formula X: Mg₂₋ₓMₓV_{2-y}P_{y}O₇, where M is Ni or Mn; x is from zero to 0.2; and y is from zero to 1. In some embodiments, x is 0 or 0.2 and/or y is 0 or 0.1. The compound may be selected from Mg_{1.5}Ni_{0.2}V₂O₇, Mg_{1.5}Mn_{0.2}V₂O₇, or Mg₂VPO₇.

Also disclosed are embodiments of a compound having a structure according to Formula XI: InZn₁₋ₓNiₓMV_{1-y}P_{y}O₇, where M is Si or Ge; x is from zero to 0.3, such as 0, 0.1 or 0.3; and y is from zero to 1, such as 0, 0.2, or 1. The compound may be selected from InZnSiVO₇, InZn_{0.9}Ni_{0.1}SiVO₇, InZnGePO₇, InZn_{0.9}Ni_{0.1}GePO₇, InZnSiPO₇, InZn_{0.9}Ni_{0.1}SiPO₇, InZn_{0.9}Ni_{0.1}GeV_{0.8}P_{0.2}O₇, or InZn_{0.9}Ni_{0.1}SiV_{0.8}P_{0.2}O₇.

Compounds have a structure according to Formula XII: Zn_{2-x-y}MₓNi_{y}V₂₋ₓAₓO₇, also are disclosed herein. With respect to Formula XII, M is Fe, Cr, Sc, Y, or La; A is Ge, or Si; x is from greater than zero to 0.1; and y is from zero to 0.1. In some embodiments, x is 0.1, and/or y is 0 or 0.1. The compound may have L*a*b values of L* from 28 to 56, a* from 15 to 28, and b* from 34 to 48. And/or the compound may be selected from Zn_{1.9}Fe_{0.1}V_{1.9}Ge_{0.1}O₇, Zn_{1.9}Fe_{0.1}V_{1.9}Si_{0.1}O₇, Zn_{1.9}Cr_{0.1}V_{1.9}Ge_{0.1}O₇, Zn_{1.9}Cr_{0.1}V_{1.9}Si_{0.1}O₇, Zn_{1.9}Sc_{0.1}V_{1.9}Si_{0.1}O₇, Zn_{1.8}Sc_{0.1}Ni_{0.1}V_{1.9}Si_{0.1}O₇, Zn_{1.9}Sc_{0.1}V_{1.9}Ge_{0.1}O₇, Zn_{1.8}Sc_{0.1}Ni_{0.1}V_{1.9}Ge_{0.1}O₇, Zn_{1.9}Y_{0.1}V_{1.9}Si_{0.1}O₇, Zn_{1.8}Y_{0.1}Ni_{0.1}V_{1.9}Si_{0.1}O₇, Zn_{1.9}Y_{0.1}V_{1.9}Ge_{0.1}O₇, Zn_{1.8}Y_{0.1}Ni_{0.1}V_{1.9}Ge_{0.1}O₇, Zn_{1.9}La_{0.1}V_{1.9}Si_{0.1}O₇, Zn_{1.8}La_{0.1}Ni_{0.1}V_{1.9}Si_{0.1}O₇, Zn_{1.9}La_{0.1}V_{1.9}Ge_{0.1}O₇, or Zn_{1.8}La_{0.1}Ni_{0.1}V_{1.9}Ge_{0.1}O₇.

Also disclosed are embodiments of a compound having a structure according to Formula XIII: Zn₁₋ₓCoₓV_{1.8}P_{0.2}O₇, where x is from greater than zero to less than 1, and may be 0.1. The compound may have L*a*b* values of L* from 25 to 26, a* from 1 to 2, and b* from 9 to 10, and/or may be Zn_{1.9}C00.1V_{1.8}P_{0.2}O₇.

Further embodiments concern a compound having a structure according to Formula XIV: Ni₁₋ₓMnₓV₂O₇, where x is from greater than zero to less than 1. In one embodiment, the compound is Ni_{1.9}Mn_{0.02}V₂O₇.

Also disclosed herein are embodiments of a composition comprising a compound disclosed herein. The composition may further comprise at least one additional component, such as a binder, a solvent, a catalyst, a thickener, a stabilizer, an emulsifier, a texturizer, an adhesion promoter, a UV stabilizer, a flattener, a preservative, a polymer, a dispersion aid, a plasticizer, a flame retardant, an oxide of a metal, or any combination thereof. The composition may be a paint, an ink, a dye, a glass, a plastic, an emulsion, a fabric, or a cosmetic preparation. In some embodiments, the composition is a glass, and the composition comprises a metal oxide. Additionally, or alternatively, the composition may further comprise at least one additional compound according to the present disclosure.

A method for making the disclosed compounds also is disclosed herein. The method may comprise selecting metals desired in the compound; providing reactants comprising the selected metals; combining the reactants in stoichiometric amounts to achieve a desired final ratio of the selected metals in the compound; and heating the combination of reactants at an effective temperature for an effective period of time to make the disclosed compound. The effective temperature may be from 600° C. to 1050° C., and/or the period of time may be from 6 hours to 12 hours. In some embodiments, heating the combination of reactants comprises heating for a first time period of from 6 hours to 12 hours, grinding the reaction the reaction mixture and reheating for a second time period of from 6 hours to 12 hours.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic diagram illustrating the difference between thortveitite (C2/m) (left) and a thortveitite-related structure (C2/c) (right).

FIG. 2 is a schematic diagram of a thortveitite-type structure (C2/m) of an exemplary A₂M₂O₇ generic compound, illustrating the trivalent A cations (orange) which are shown as edge-sharing distorted AO₆ octahedra forming a 2D hexagonal network perpendicular to the c axis (left), and tetravalent M cations (cyan) shown as M₂O₇ diorthogroups connecting the AO₆ hexagonal sheets to form a 3D structure (right), with oxygen ions shown as small red spheres.

FIG. 3 is a schematic diagram illustrating a crystal structure (P21/c) of ZnMV₂O₇ (M=Co, Ni) showing zigzag chains of edge-sharing (Zn/M)O₆ octahedra connected by V₂O₇ diorthogroups.

FIG. 4 is a schematic diagram illustrating how the L*a*b* values correspond to different colors.

FIG. 5 is a table illustrating exemplary compounds according to Formula I.

FIG. 6 is a table illustrating exemplary compounds according to Formula II.

FIG. 7 is a table illustrating exemplary compounds according to Formula III.

FIG. 8 is a table illustrating exemplary compounds according to Formula IV.

FIG. 9 is a table illustrating exemplary compounds according to Formula V.

FIG. 10 is a table illustrating exemplary compounds according to Formula VI.

FIG. 11 is a table illustrating exemplary compounds according to Formula VII.

FIG. 12 is a table illustrating exemplary compounds according to Formula VIII.

FIG. 13 is a table illustrating exemplary compounds according to Formula IX.

FIG. 14 is a table illustrating exemplary compounds according to Formula X.

FIG. 15 is a table illustrating exemplary compounds according to Formula XI.

FIG. 16 is a table illustrating exemplary compounds according to Formula XII.

FIG. 17 is a table illustrating exemplary compounds according to Formula XIII.

FIG. 18 is a table illustrating exemplary compounds according to Formula XIV.

FIG. 19 is a digital image illustrating the colors of exemplary solid solutions according to the disclosure.

FIG. 20 is a graph illustrating the differences in the X-ray diffraction spectra of exemplary compounds according to the disclosure.

FIG. 21 is a graph of R angles and cell volumes versus formulation, illustrating the R angles and cell volumes as a function of x of exemplary compounds having a formula Zn₂₋ₓNiₓV₂O₇ (0≤x≤0.3).

FIG. 22 is a graph of absorbance versus wavelength, illustrating the diffuse reflectance spectra for exemplary Zn₂₋ₓNiₓV₂O₇ (0≤x≤0.3) solid solutions.

FIG. 23 is a graph of reflectance versus wavelength, illustrating the NIR reflectance spectra for exemplary Zn₂₋ₓNiₓV₂O₇ (0≤x≤0.3) samples.

FIG. 24 is a graph of magnetic susceptibility versus temperature, illustrating the inverse magnetic susceptibility of Zn₂₋ₓNiₓV₂O₇ (x=0.2 and 0.23) phases.

FIG. 25 is a graph illustrating the X-ray diffraction spectra of Zn_{1.77}Ni_{0.23}V₂O₇ before and after exposure to dilute aqueous acids.

### DETAILED DESCRIPTION

### I. Definitions

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements. All references, including patents and patent applications cited herein, are incorporated by reference in their entirety, unless otherwise specified.

Unless otherwise indicated, all numbers expressing quantities of components, molecular weights, percentages, temperatures, times, and so forth, as used in the specification or claims, are to be understood as being modified by the term “about.” Accordingly, unless otherwise indicated, implicitly or explicitly, the numerical parameters set forth are approximations that may depend on the desired properties sought and/or limits of detection under standard test conditions/methods. When directly and explicitly distinguishing embodiments from discussed prior art, the embodiment numbers are not approximates unless the word “about” is expressly recited.

Unless explained otherwise, all technical and scientific terms used herein have the same meaning as commonly understood by one of ordinary skill in the art to which this disclosure pertains. Although methods and materials similar or equivalent to those described herein can be used in the practice or testing of the present disclosure, suitable methods and materials are described below. The materials, methods, and examples are illustrative only and not intended to be limiting.

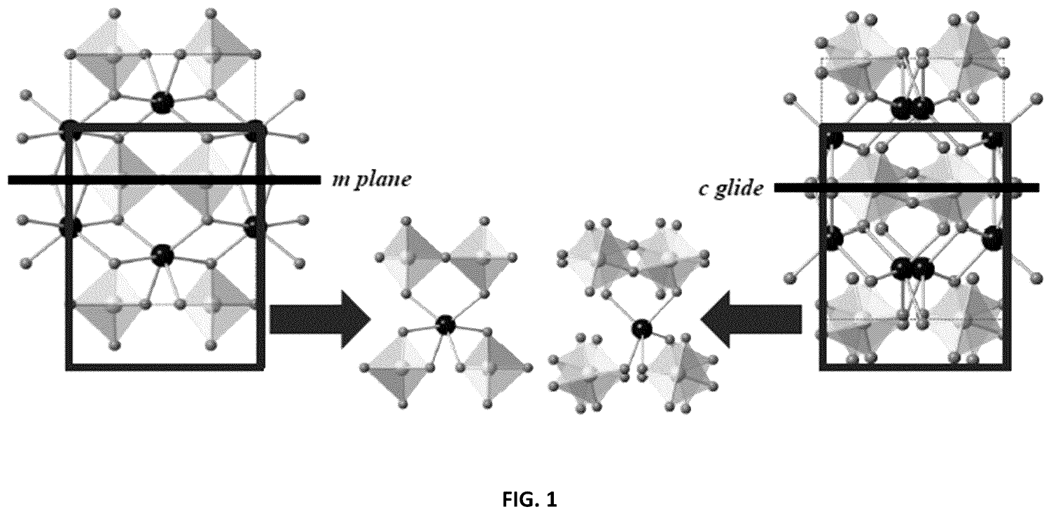

The terms “thortveitite-related,” “thortveitite-type,” “thortveitite-base” and the like refer to compounds A₂M₂O₇ that have a crystalline structure based on the thortveitite crystal structure but who's structure may vary from a thortveitite structure because of the displacement of atoms present in the compound and the rotation of the tetrahedra in the M₂O₇ diorthogroups. This structural variation leads to the breaking of the A-O bonds and the formation of distorted AO₅ trigonal bipyramids (FIG. 1).

### II. Overview

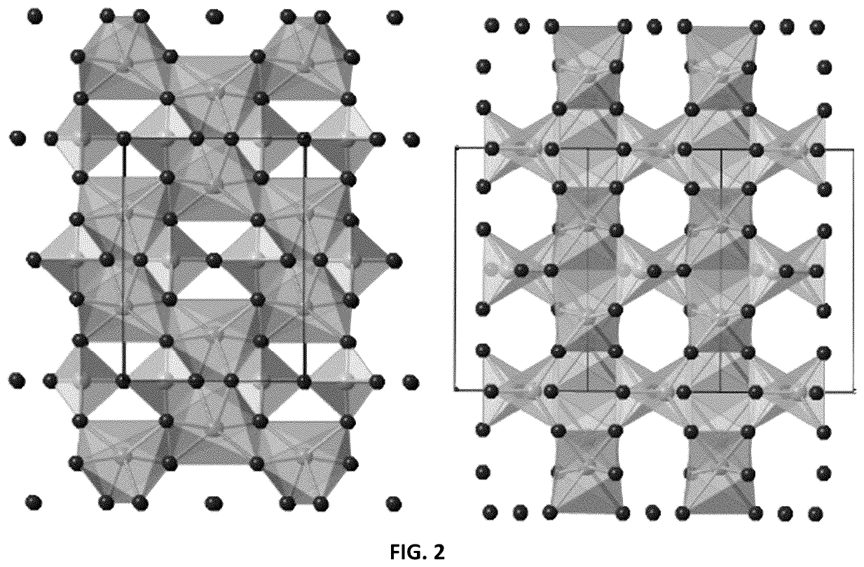

Thortveitite is a granitic pegmatite mineral that consists of scandium yttrium silicate (Sc,Y)₂Si₂O₇, which is generally imbedded in spessartite, beryl, and magnetite. It shows the color from greenish, grey, yellow to white in nature. The general formula of thortveitite structure is A₂M₂O₇. The A₂M₂O₇ family can form various complex structures based on synthesis conditions, such as pyrochlore, dichromate, weberite, thortveitite and thortveitite-related structures. Thortveitite structure (C2/m) can be described as the combination of a three-dimensional framework of M₂O₇ diorthogroups and hexagonal networks formed by AO₆ edge-sharing octahedrons (FIG. 2), where A sites could be rare earth, transition metals, or trivalent elements (Ex: Sc, In, Y, Gd, Fe, etc.), and M sites could be tetravalent silicon or germanium. The coordination numbers of A sites and M sites are six and four, respectively.

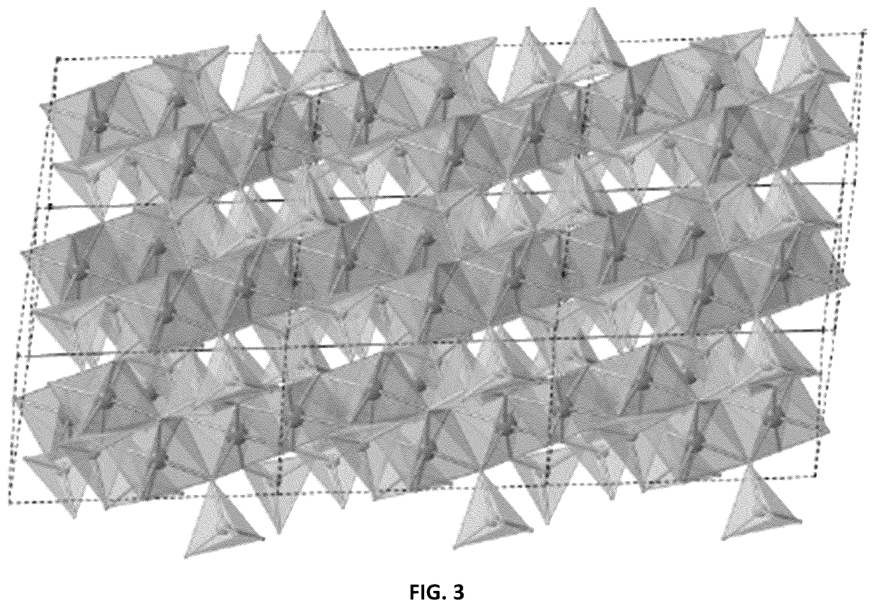

Solid solutions of the thortveitite-related structure, (Zn, M)₂V₂O₇, has been reported with different divalent cations (M=Cu, Co, Mg, Ni, Ca, Mn, Cd) in five-coordinated sites. Based on the crystal field theory, transition metals in non-centrosymmetric structures are subject to allowed d-d transition due to crystal field splitting, especially in TBP coordination. The thortveitite-related structure, Zn₂V₂O₇ (C2/c), consists of highly distorted TBP sites for Zn and tetrahedral sites for vanadium. The difference between thortveitite (C2/m) and thortveitite-related structure (C2/c) is shown in FIG. 1. The twisted M₂O₇ diorthogroups in C2/c break one of the bridging oxygens between the diorthogroups and the hexagonal AO₆ networks, resulting in distorted AO₅ trigonal bipyramids forming edge-sharing 1D chains along the c direction. Solid solutions of thortveitite-related (Zn,M)₂V₂O₇ (where M is divalent cations such as Cu, Ni, and/or Co) were explored for their structural and magnetic properties, among which ZnCoV₂O₇ and ZnNiV₂O₇ were found to crystallize with the so-called dichromate structure type, showing monoclinic symmetry, space group P21/c (FIG. 3). However, there was no optical study on Zn₂V₂O₇ based compounds with thortveitite-related structures.

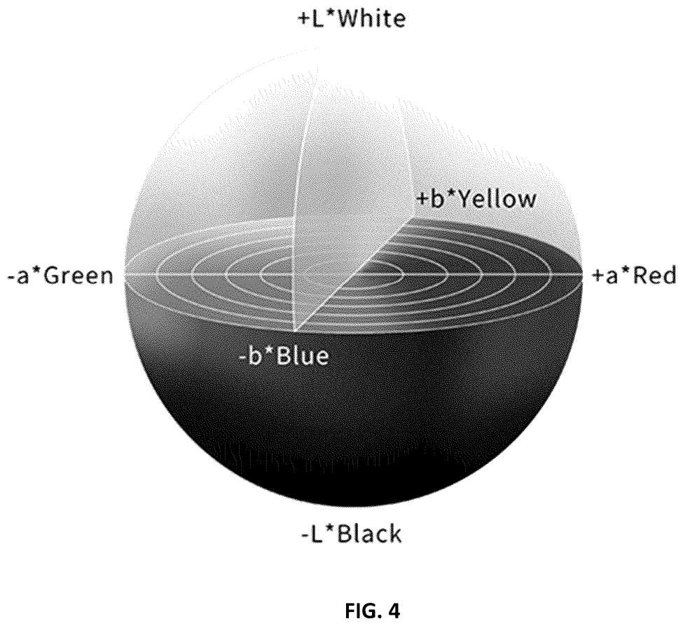

The hue (color), chroma (vividness/dullness), and brightness of the powder samples are characterized using the CIE L*a*b* color space. A unique color can be described precisely by 3-dimensional color coordinates L*, a*, and b* (FIG. 4). The vertical axis L* gives the brightness from 0 (black) to 100 (white). The value of a* shows colors from green to red (− to +) and b* from blue to yellow (− to +) with neutral gray values at a*=0 and b*=0.

### III. Compounds

Disclosed herein are embodiments of a compound having a thortveitite-related structure that are chromophoric and may be useful as pigments. In some embodiments, the compounds are durable with respect to an acid stability test, indicating that the pigments will not substantially change color when exposed to weak acids, such as rain, and therefore may be useful in applications where they will be exposed to weather. The compounds disclosed herein typically are inexpensive to synthesize from earth-abundant, environmentally-friendly elements or minerals, and therefore are advantageous over existing pigments in the art.

Embodiments of the disclosed materials satisfy the general formula A₂₋ₓA′ₓM_{2-y}M′_{y}O₇, where A and A′ are divalent or trivalent cations including rare earth elements (for example, A and A′ independently may be Zn, Ni, Fe, Mn, Cr, Co, Mg, Cu, Ca, Sr, Ba, Al, Ga, or In, or rare earth elements such as Y, La, Ce, Pr, Nd, Sm, Eu, Gd, Tb, Dy, Ho, Er, Tm, Yb or Lu, or any combination thereof); M and M′ are tetravalent or pentavalent anions (M=V, P, Ge, Si, or a combination thereof); mostly x and y are greater than 0.0 but less than or equal to 2. The general formulas are compositional formulas and do not necessarily imply chemical structure and/or connectivity.

### A. Formula I

In some embodiments, the compound has a structure according to Formula I

Zn₂₋ₓNiₓV₂O₇ Formula I

With respect to Formula I, x is from greater than 0.2 to 0.8 (0.2≤x≤0.8), or x is from 1.2 to 1.8 (1.2≤x≤1.8). In some embodiments, x is from greater than 0.2 to less than 0.5 (0.2≤x≤0.5).

The compound of Formula I may have L*a*b* values of L* from 34 to 60, a* from 10 to 27, and b* from 19 to 60. In some embodiments, 0.2≤x≤0.8 and the compound has L*a*b values of L* from 34 to 51, a* from 17 to 27, and b* from 19 to 49. In other embodiments, 1.2≤x≤1.8 and the compound has L*a*b values of L* from 51 to 60, a* from 10 to 14, and b* from 48 to 60.

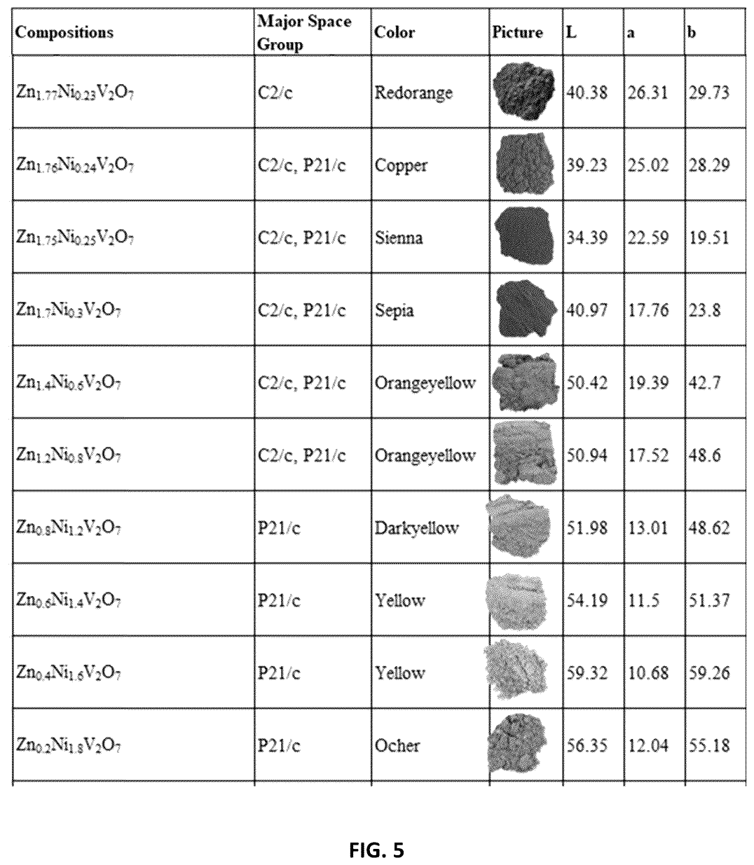

Exemplary compounds according to Formula I are shown in Table 1 and also in FIG. 5.

TABLE 1

| Compound | L* | a* | b* |
|---|---|---|---|
| Zn_{1.77}Ni_{0.23}V₂O₇ | 40.38 | 26.31 | 29.73 |
| Zn_{1.76}Ni_{0.24}V₂O₇ | 39.23 | 25.02 | 28.29 |
| Zn_{1.75}Ni_{0.25}V₂O₇ | 34.39 | 22.59 | 19.51 |
| Zn_{1.7}Ni_{0.3}V₂O₇ | 40.97 | 17.76 | 23.8 |
| Zn_{1.4}Ni_{0.6}V₂O₇ | 50.42 | 19.39 | 42.7 |
| Zn_{1.2}Ni_{0.8}V₂O₇ | 50.94 | 17.52 | 48.6 |
| Zn_{0.8}Ni_{1.2}V₂O₇ | 51.98 | 13.01 | 48.62 |
| Zn_{0.6}Ni_{1.4}V₂O₇ | 54.19 | 11.5 | 51.37 |
| Zn_{0.4}Ni_{1.6}V₂O₇ | 59.32 | 10.68 | 59.26 |
| Zn_{0.2}Ni_{1.8}V₂O₇ | 56.35 | 12.04 | 55.18 |

### B. Formula II

In some embodiments, the compound has a structure according to Formula

Zn₂₂MnₓMₓV₂O₇ Formula II

With respect to Formula II, x is from greater than zero to 0.05 (0≤x≤0.05) and M is divalent cations Mg or Ni. The compound of Formula II may have L*a*b* values of L* from 22 to 37, a* from 7 to 19, and b* from 3 to 2.

In some embodiments, M is Mg, and the compound has L*a*b* values of L* from 32 to 36, a* from 10 to 19, and b* from 11 to 22. In other embodiments, M is Ni, and the compound has L*a*b* values of L* from 22 to 37, a* from 7 to 17, and b* from 3 to 17.

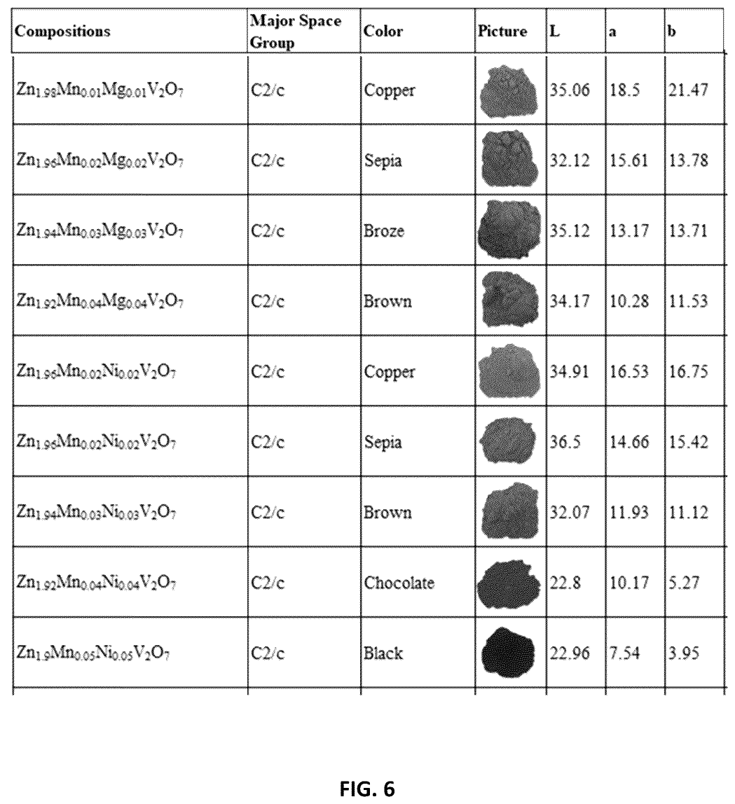

Exemplary compounds according to Formula II are shown in Table 2 and also in FIG. 6.

TABLE 2

| Compound | L* | a* | b* |
|---|---|---|---|
| Zn_{1.98}Mn_{0.01}Mg_{0.01}V₂O₇ | 35.06 | 18.5 | 21.47 |
| Zn_{1.96}Mn_{0.02}Mg_{0.02}V₂O₇ | 32.12 | 15.61 | 13.78 |
| Zn_{1.94}Mn_{0.03}Mg_{0.03}V₂O₇ | 35.12 | 13.17 | 13.71 |
| Zn_{1.92}Mn_{0.04}Mg_{0.04}V₂O₇ | 34.17 | 10.28 | 11.53 |
| Zn_{1.96}Mn_{0.02}Ni_{0.02}V₂O₇ | 34.91 | 16.53 | 16.75 |
| Zn_{1.96}Mn_{0.02}Ni_{0.02}V₂O₇ | 36.5 | 14.66 | 15.42 |
| Zn_{1.94}Mn_{0.03}Ni_{0.03}V₂O₇ | 32.07 | 11.93 | 11.12 |
| Zn_{1.92}Mn_{0.04}Ni_{0.04}V₂O₇ | 22.8 | 10.17 | 5.27 |
| Zn_{1.9}Mn_{0.05}Ni_{0.05}V₂O₇ | 22.96 | 7.54 | 3.95 |

### C. Formula III

In some embodiments, the compound has a structure according to Formula III

In₂₋ₓZnₓGe₂₋ₓVₓO₇ Formula III

With respect to Formula III, x is from greater than zero to less than 2 (0≤x≤2). In certain embodiments, x is selected from 0.1, 0.3, 0.5, 1, 1.5, 1.7, 1.8, or from 1.90 to 1.98, such as 0.1, 0.3, 0.5, 1, 1.5, 1.7, 1.8, 1.90, 1.93, 1.94, 1.95, or 1.98.

In some embodiments, a compound of Formula III has L*a*b values of L* from 48 to 67, a* from −3 to 7, and b* from 26 to 56.

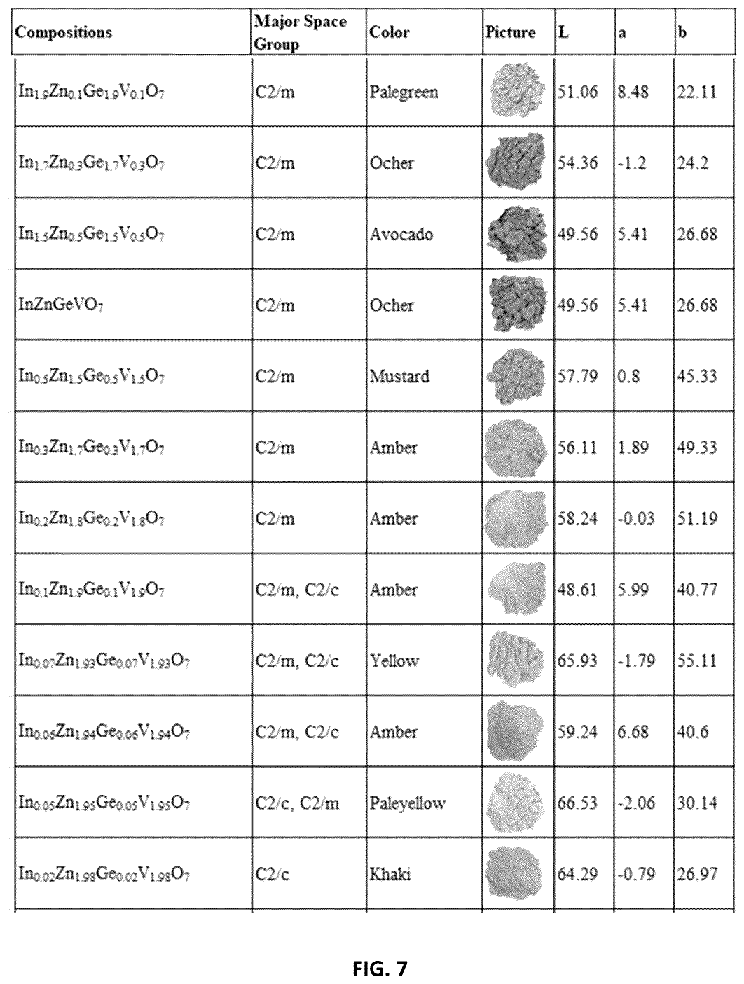

Exemplary compounds according to Formula III are shown in Table 3 and also in FIG. 7.

TABLE 3

| Compound | L* | a* | b* |
|---|---|---|---|
| In_{1.9}Zn_{0.1}Ge_{1.9}V_{0.1}O₇ | 51.06 | 8.48 | 22.11 |
| In_{1.7}Zn_{0.3}Ge_{1.7}V_{0.3}O₇ | 54.36 | −1.2 | 24.2 |
| In_{1.5}Zn_{0.5}Ge_{1.5}V_{0.5}O₇ | 49.56 | 5.41 | 26.68 |
| InZnGeVO₇ | 49.56 | 5.41 | 26.68 |
| In_{0.5}Zn_{1.5}Ge_{0.5}V_{1.5}O₇ | 57.79 | 0.8 | 45.33 |
| In_{0.3}Zn_{1.7}Ge_{0.3}V_{1.7}O₇ | 56.11 | 1.89 | 49.33 |
| In_{0.2}Zn_{1.8}Ge_{0.2}V_{1.8}O₇ | 58.24 | −0.03 | 51.19 |
| In_{0.1}Zn_{1.9}Ge_{0.1}V_{1.9}O₇ | 48.61 | 5.99 | 40.77 |
| In_{0.07}Zn_{1.93}Ge_{0.07}V_{1.93}O₇ | 65.93 | −1.79 | 55.11 |
| In_{0.06}Zn_{1.94}Ge_{0.06}V_{1.94}O₇ | 59.24 | 6.68 | 40.6 |
| In_{0.05}Zn_{1.95}Ge_{0.05}V_{1.95}O₇ | 66.53 | −2.06 | 30.14 |
| In_{0.02}Zn_{1.98}Ge_{0.02}V_{1.98}O₇ | 64.29 | −0.79 | 26.97 |

### D. Formula IV

In some embodiments, the compound has a Formula IV

InZn₁₋ₓNiₓGeVO₇ Formula IV.

With respect to Formula IV, x is from greater than 0 to 1 (0≤x≤1). In certain embodiments, x is selected from 0.1, 0.3, 0.5, 0.7, or 1.0. In some embodiments, a compound has L*a*b values of L* from 48 to 59, a* from 1 to 13, and b* from 31 to 46.

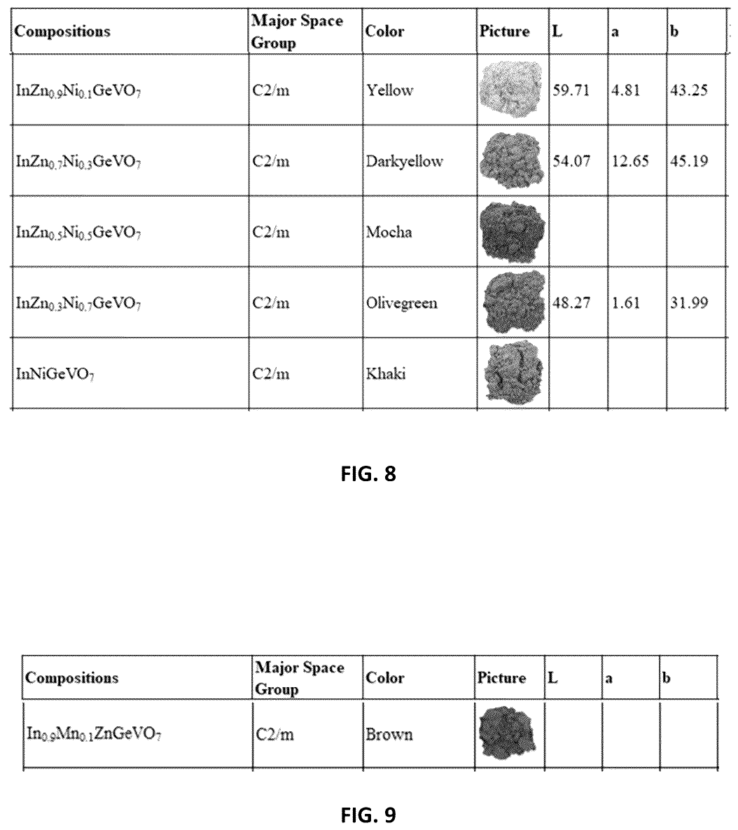

Exemplary compounds according to Formula IV are shown in Table 4 and also in FIG. 8.

TABLE 4

| Compound | L* | a* | b* |
|---|---|---|---|
| InZn0.9Ni0.1GeVO7 | 59.71 | 4.81 | 43.25 |
| InZn0.7Ni0.3GeVO7 | 54.07 | 12.65 | 45.19 |
| InZn0.5Ni0.5GeVO7 | ND | ND | ND |
| InZn0.3Ni0.7GeVO7 | 48.27 | 1.61 | 31.99 |
| InNiGeVO7 | ND | ND | ND |

ND = not determined

### E. Formula V

In some embodiments, the compound has a Formula V

In₁₋ₓMnₓZnGeVO₇ Formula V.

With respect to Formula V, x is from greater than 0 to less than 1 (0≤x≤1), such as from greater than zero to 0.5. In certain embodiments, x is 0.1.

An example compound according to Formula V is In_{0.9}Mn_{0.1}ZnGeVO₇ (FIG. 9).

### F. Formula VI

In some embodiments, the compound has a Formula VI

Zn_{1.77-x}Ni_{0.23}MₓV_{2-y}P_{y}O₇ Formula VI.

With respect to Formula VI, x is from zero to 0.1 (0≤x≤0.1) and y is from zero to 2 (0≤y≤2). M is Mg, Ca, (NaAl), (NaGa). (KAl), or (KGa). In some embodiments, x is 0 or x is 0.1. In particular embodiments, y is 0, 0.2 or 2.

In some embodiments, a compound of Formula VI has L*a*b values of L* from 35 to 77, a* from −2 to 26, and b* from 23 to 37.

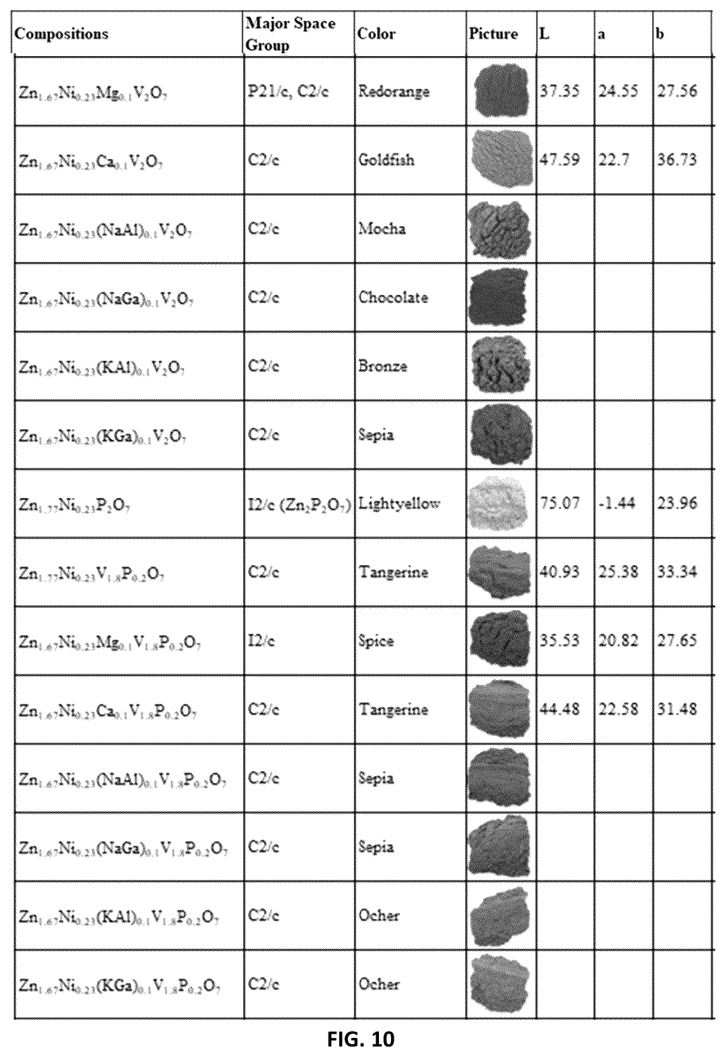

Exemplary compounds according to Formula VI are shown in Table 5 and also in FIG. 10.

TABLE 5

| Compound | L* | a* | b* |
|---|---|---|---|
| Zn_{1.67}Ni_{0.23}Mg_{0.1}V₂O₇ | 37.35 | 24.55 | 27.56 |
| Zn_{1.67}Ni_{0.23}Ca_{0.1}V₂O₇ | 47.59 | 22.7 | 36.73 |
| Zn_{1.67}Ni_{0.23}(NaAl)_{0.1}V₂O₇ | ND | ND | ND |
| Zn_{1.67}Ni_{0.23}(NaGa)_{0.1}V₂O₇ | ND | ND | ND |
| Zn_{1.67}Ni_{0.23}(KAl)_{0.1}V₂O₇ | ND | ND | ND |
| Zn_{1.67}Ni_{0.23}(KGa)_{0.1}V₂O₇ | ND | ND | ND |
| Zn_{1.77}Ni_{0.23}P₂O₇ | 75.07 | −1.44 | 23.96 |
| Zn_{1.77}Ni_{0.23}V_{1.8}P_{0.2}O₇ | 40.93 | 25.38 | 33.34 |
| Zn_{1.67}Ni_{0.23}Mg_{0.1}V_{1.8}P_{0.2}O₇ | 35.53 | 20.82 | 27.65 |
| Zn_{1.67}Ni_{0.23}Ca_{0.1}V_{1.8}P_{0.2}O₇ | 44.48 | 22.58 | 31.48 |
| Zn_{1.67}Ni_{0.23}(NaAl)_{0.1}V_{1.8}P_{0.2}O₇ | ND | ND | ND |
| Zn_{1.67}Ni_{0.23}(NaGa)_{0.1}V_{1.8}P_{0.2}O₇ | ND | ND | ND |
| Zn_{1.67}Ni_{0.23}(KAl)_{0.1}V_{1.8}P_{0.2}O₇ | ND | ND | ND |
| Zn_{1.67}Ni_{0.23}(KGa)_{0.1}V_{1.8}P_{0.2}O₇ | ND | ND | ND |

ND = not determined

### G. Formula VII

In some embodiments, the compound has a Formula VII

Zn_{1.8}Cu_{0.1}M_{0.1}V₂O₇ Formula VII.

With respect to Formula VII, M is divalent cations Ni, Mn, Mg, or Ca. In some embodiments, a compound of Formula VII has L*a*b* values of L* from 40 to 59, a* from 1 to 16, and b* from 26 to 44.

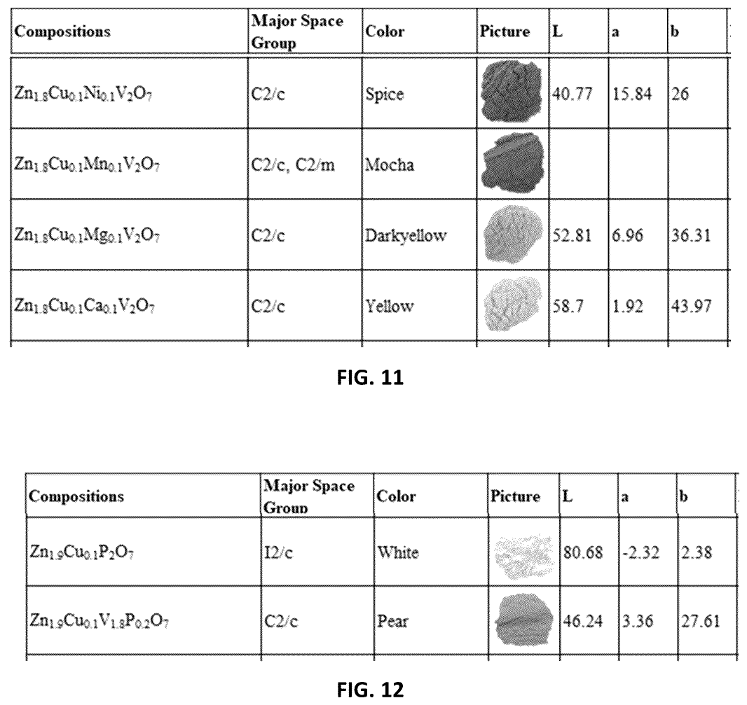

Exemplary compounds according to Formula VII are shown in Table 6 and also in FIG. 11.

TABLE 6

| Compound | L* | a* | b* |
|---|---|---|---|
| Zn_{1.8}Cu_{0.1}Ni_{0.1}V₂O₇ | 40.77 | 15.84 | 26 |
| Zn_{1.8}Cu_{0.1}Mn_{0.1}V₂O₇ | ND | ND | ND |
| Zn_{1.8}Cu_{0.1}Mg_{0.1}V₂O₇ | 52.81 | 6.96 | 36.31 |
| Zn_{1.8}Cu_{0.1}Ca_{0.1}V₂O₇ | 58.7 | 1.92 | 43.97 |

ND = not determined

### H. Formula VIII

In some embodiments, the compound has a Formula VIII

Zn_{1.9}Cu_{0.1}VₓP₂₋ₓO₇ Formula VIII.

With respect to Formula VIII, x is from zero to 1.8 (0≤x≤1.8). In certain embodiments, x is 0 or x is 1.8. In some embodiments, a compound of Formula VII has L*a*b* values of L* from 46 to 81, a* from −3 to 4, and b* from 2 to 28.

Exemplary compounds according to Formula VIII are shown in Table 7 and also in FIG. 12.

TABLE 7

| Compound | L* | a* | b* |
|---|---|---|---|
| Zn_{1.9}Cu_{0.1}P₂O₇ | 80.68 | −2.32 | 2.38 |
| Zn_{1.9}Cu_{0.1}V_{1.8}P_{0.2}O₇ | 46.24 | 3.36 | 27.61 |

### I. Formula IX

In some embodiments, the compound has a Formula IX

Zn_{2-x-y}MnₓM_{y}V_{2-z}P_{z}O₇ Formula IX.

With respect to Formula IX, M is divalent cations Ni, Mg, or Ca.
x is from greater than zero to 0.5 (0≤x≤0.5).
y is from zero to 0.1 (0≤y≤0.1).
z is from zero to 1 (0≤z≤1).

In some embodiments, x=0.02, 0.1, or 0.5.

In some embodiments, y=0 or y=0.1.

In some embodiments, z=0, z=0.2, or z=1.

In some embodiments, a compound of Formula IX has L*a*b values of L* from 33 to 41, a* from 17 to 22, and b* from 21 to 24.

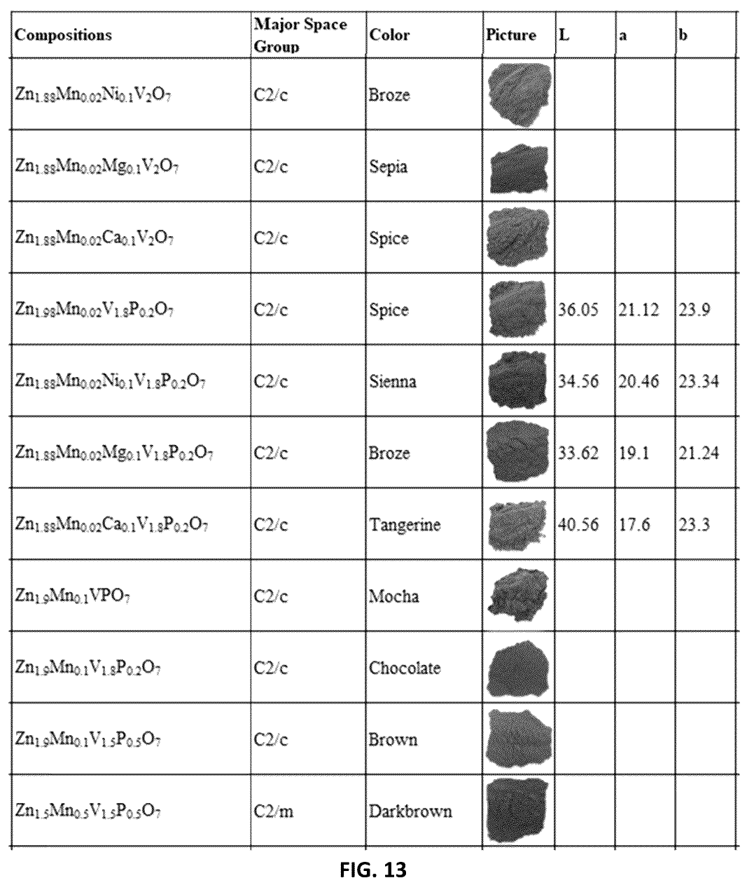

Exemplary compounds according to Formula IX are shown in Table 8 and also in FIG. 13.

TABLE 8

| Compound | L* | a* | b* |
|---|---|---|---|
| Zn_{1.88}Mn_{0.02}Ni_{0.1}V₂O₇ | ND | ND | ND |
| Zn_{1.88}Mn_{0.02}Mg_{0.1}V₂O₇ | ND | ND | ND |
| Zn_{1.88}Mn_{0.02}Ca_{0.1}V₂O₇ | ND | ND | ND |
| Zn_{1.98}Mn_{0.02}V_{1.8}P_{0.2}O₇ | 36.05 | 21.12 | 23.9 |
| Zn_{1.88}Mn_{0.02}Ni_{0.1}V_{1.8}P_{0.2}O₇ | 34.56 | 20.46 | 23.34 |
| Zn_{1.88}Mn_{0.02}Mg_{0.1}V_{1.8}P_{0.2}O₇ | 33.62 | 19.1 | 21.24 |
| Zn_{1.88}Mn_{0.02}Ca_{0.1}V_{1.8}P_{0.2}O₇ | 40.56 | 17.6 | 23.3 |
| Zn_{1.9}Mn_{0.1}VPO₇ | ND | ND | ND |
| Zn_{1.9}Mn_{0.1}V_{1.8}P_{0.2}O₇ | ND | ND | ND |
| Zn_{1.9}Mn_{0.1}V_{1.5}P_{0.5}O₇ | ND | ND | ND |
| Zn_{1.5}Mn_{0.5}V_{1.5}P_{0.5}O₇ | ND | ND | ND |

ND = not determined

### J. Formula X

In some embodiments, the compound has a Formula X

Mg₂₋ₓMₓV_{2-y}P_{y}O₇ Formula X.

With respect to Formula X, M is divalent cations Ni or Mn. x is from zero to 0.2 (0≤x≤0.2), and y is from zero to 1 (0≤y≤1).

In some embodiments, x=0 or x=0.2.

In some embodiments, y=0 or y=1.

In some embodiments, a compound of Formula X has L*a*b values of L* from 36 to 67, a* from 4 to 14, and b* from 15 to 46.

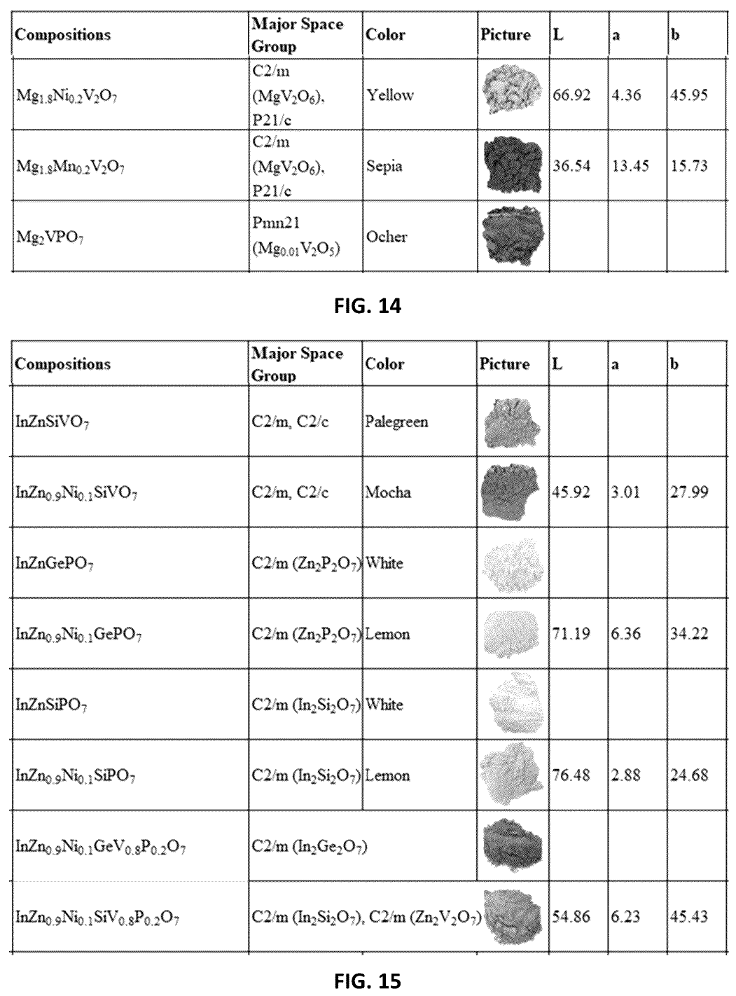

Exemplary compounds according to Formula X are shown in Table 9 and also in FIG. 14.

TABLE 9

| Compound | L* | a* | b* |
|---|---|---|---|
| Mg_{1.8}Ni_{0.2}V₂O₇ | 66.92 | 4.36 | 45.95 |
| Mg_{1.8}Mn_{0.2}V₂O₇ | 36.54 | 13.45 | 15.73 |
| Mg₂VPO₇ | ND | ND | ND |

ND = not determined

### K. Formula XI

In some embodiments, the compound has a Formula XI

InZn₁₋ₓNiₓMV_{1-y}P_{y}O₇ Formula XI.

With respect to Formula XI, M is Si or Ge.
x is from zero to 0.3 (0≤x≤0.3).
y is from zero to 1 (0≤y≤1).

In some embodiments, x=0 or 0.1.

In some embodiments, y=0, 0.2 or 1.

In some embodiments, a compound of Formula XI has L*a*b values of L* from 45 to 77, a* from 2 to 7, and b* from 24 to 46.

Exemplary compounds according to Formula XI are shown in Table 10 and also in FIG. 15.

TABLE 10

| Compound | L* | a* | b* |
|---|---|---|---|
| InZnSiVO₇ | ND | ND | ND |
| InZn_{0.9}Ni_{0.1}SiVO₇ | 45.92 | 3.01 | 27.99 |
| InZnGePO₇ | ND | ND | ND |
| InZn_{0.9}Ni_{0.1}GePO₇ | 71.19 | 6.36 | 34.22 |
| InZnSiPO₇ | ND | ND | ND |
| InZn_{0.9}Ni_{0.1}SiPO₇ | 76.48 | 2.88 | 24.68 |
| InZn_{0.9}Ni_{0.1}GeV_{0.8}P_{0.2}O₇ | ND | ND | ND |
| InZn_{0.9}Ni_{0.1}SiV_{0.8}P_{0.2}O₇ | 54.86 | 6.23 | 45.43 |

ND = not determined

### L. Formula XII

In some embodiments, the compound has a Formula XII

Zn_{2-x-y}MₓNi_{y}V₂₋ₓAₓO₇ Formula XII.

With respect to Formula XII, M is trivalent cations Fe, Cr, Sc, Y, or La.
A is Ge, or Si.
x is from greater than zero to 0.1 (0≤x≤0.1). In some embodiments, x is 0.1.
y is from zero to 0.1. In some embodiments, y is 0, but in other embodiments, y is 0.1.

In some embodiments, a compound of Formula XII has L*a*b values of L* from 28 to 56, a* from 15 to 28, and b* from 34 to 48.

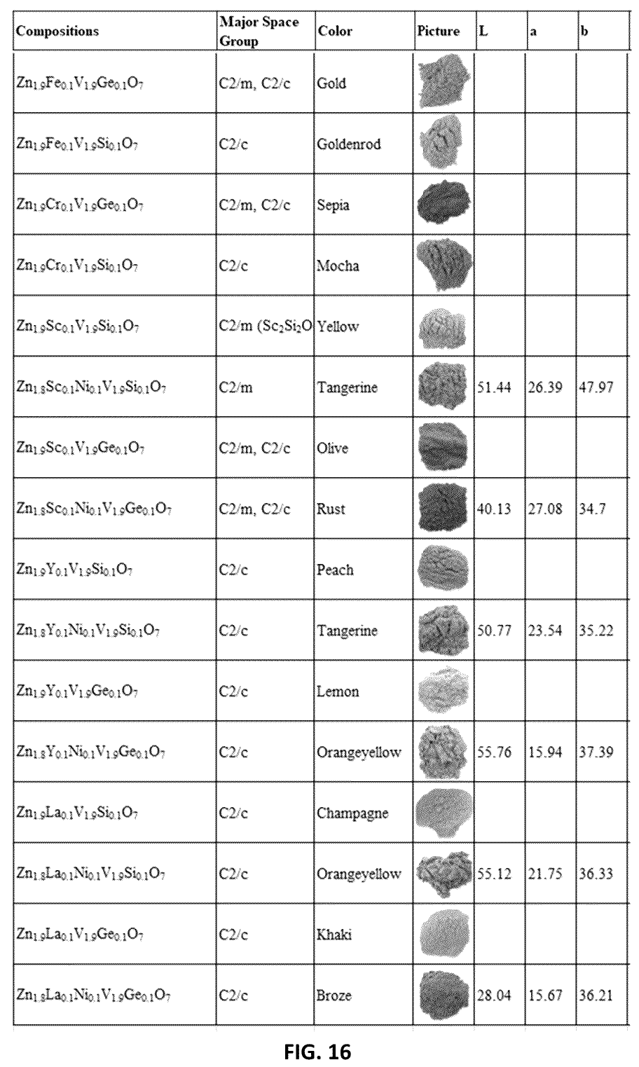

Exemplary compounds according to Formula XII are shown in Table 11 and also in FIG. 16.

TABLE 11

| Compound | L* | a* | b* |
|---|---|---|---|
| Zn_{1.9}Fe_{0.1}V_{1.9}Ge_{0.1}O₇ | ND | ND | ND |
| Zn_{1.9}Fe_{0.1}V_{1.9}Si_{0.1}O₇ | ND | ND | ND |
| Zn_{1.9}Cr_{0.1}V_{1.9}Ge_{0.1}O₇ | ND | ND | ND |
| Zn_{1.9}Cr_{0.1}V_{1.9}Si_{0.1}O₇ | ND | ND | ND |
| Zn_{1.9}Sc_{0.1}V_{1.9}Si_{0.1}O₇ | ND | ND | ND |
| Zn_{1.8}Sc_{0.1}Ni_{0.1}V_{1.9}Si_{0.1}O₇ | 51.44 | 26.39 | 47.97 |
| Zn_{1.9}Sc_{0.1}V_{1.9}Ge_{0.1}O₇ | ND | ND | ND |
| Zn_{1.8}Sc_{0.1}N_{i0.1}V_{1.9}Ge_{0.1}O₇ | 40.13 | 27.08 | 34.7 |
| Zn_{1.9}Y_{0.1}V_{1.9}Si_{0.1}O₇ | ND | ND | ND |
| Zn_{1.8}Y_{0.1}Ni_{0.1}V_{1.9}Si_{0.1}O₇ | 50.77 | 23.54 | 35.22 |
| Zn1_{.9}Y_{0.1}V_{1.9}Ge_{0.1}O₇ | ND | ND | ND |
| Zn_{1.8}Y_{0.1}Ni_{0.1}V_{1.9}Ge_{0.1}O₇ | 55.76 | 15.94 | 37.39 |
| Zn_{1.9}La_{0.1}V_{1.9}Si_{0.1}O₇ | ND | ND | ND |
| Zn_{1.8}La_{0.1}Ni_{0.1}V_{1.9}Si_{0.1}O₇ | 55.12 | 21.75 | 36.33 |
| Zn_{1.9}La_{0.1}V_{1.9}Ge_{0.1}O₇ | ND | ND | ND |
| Zn_{1.8}La_{0.1}Ni_{0.1}V_{1.9}Ge_{0.1}O₇ | 28.04 | 15.67 | 36.21 |

ND = not determined

### M. Formula XIII

In some embodiments, the compound has a Formula XIII

Zn₁₋ₓCoₓV_{1.8}P_{0.2}O₇ Formula XIII.

With respect to Formula XIII, x is from greater than zero to less than 1 (0≤x≤1), such as from greater than zero to 0.5. In certain embodiments, x is 0.1.

In some embodiments, a compound of Formula XIII has L*a*b* values of L* from 25 to 26, a* from i to 2, and b* from 9 to 10.

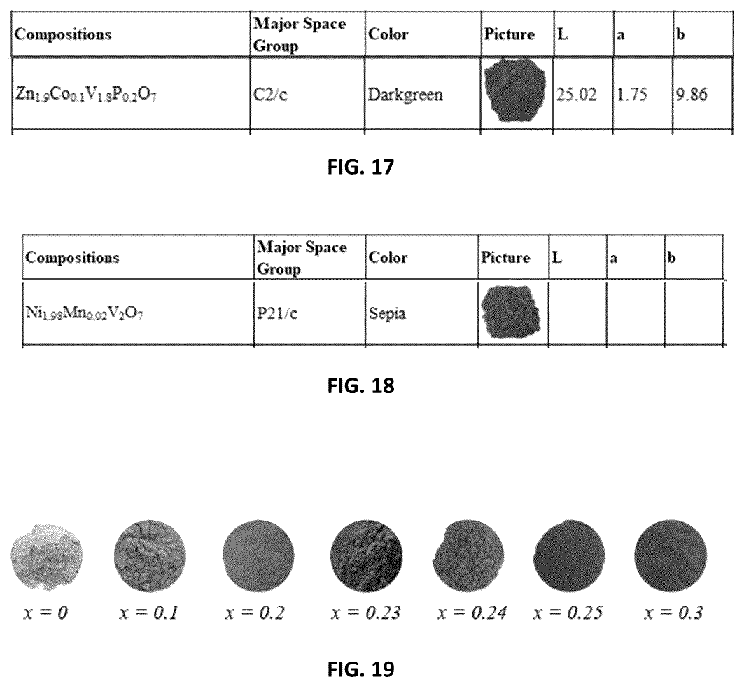

An example compound according to Formula XIII is Zn_{1.9}Co_{0.1}V_{1.8}P_{0.2}O₇ (FIG. 17).

### N. Formula XIV

In some embodiments, the compound has a Formula XIV

Ni₂₋ₓMnₓV₂O₇ Formula XIV.

With respect to Formula XIV, x is from greater than zero to less than 1 (0≤x≤1), such as from greater than zero to less than 0.1. In certain embodiments, x is 0.02.

An example compound according to Formula XIV is Ni_{1.98}Mn_{0.02}V₂O₇ (FIG. 18).

### IV. Synthesis

The disclosed compounds are made from standard techniques known to persons of ordinary skill in the art. In some embodiments, traditional solid state reactions were used. But other synthesis routes, such as, but not limited to, sol-gel solution method and hydrothermal low temperature preparation also can be used.

In some embodiments, stoichiometric amount of suitable starting materials are weighed, mixed, ground, and pelletized. Suitable starting materials include, but are not limited to, compounds having a formula ACO₃ where A=Mg, Ca, Sr, or Ba; compounds having a formula M₂O₃, where M=Al, Ga, In, Mn, Fe, Cr, Sc, Y, La, Ce, Pr, Nd, Sm, Eu, Gd, Tb, Dy, Ho, Er, Tm, Yb, or Lu; compounds having a formula M′O₂, where M′=Si, or Ge; compounds having a formula M″O, where M″=Ni, Mn, Cu, Zn, or Fe; compounds having a formula M′″₂O₅, where M′″=V, or P; and Co₃O₄. A person of ordinary skill in the art understands how to select the specific combination of starting materials to provide the required stoichiometric amounts of each desired metal and oxygen to produce the desired final compound.

The resulting pellets then are heated to a suitable temperature, such as a temperature of from 500° C. or less to 1200° C. or more, such as from 600° C. to 1050° C. for a suitable time to facilitate forming the desired compound. The heating time may be from 4 hours or less to 18 hours or more, such as from 6 hours to 12 hours. The heating may be performed in air (i.e., the ambient atmosphere). Additionally, the reaction mixture heated multiple times to the reaction temperature, such as 1, 2, 3 or more times, with intermediate grinding. The heating is ramped at a suitable rate to facilitate the reaction proceeding, such as a ramp rate of 300° C./hour.

The compounds are analyzed by X-ray diffraction, NIR reflectance spectra, magnetic susceptibility, and stability to acid exposure. Diffuse reflectance spectra is used to determine the spectral characteristics of the compounds, and the L*a*b* color coordinates are determined for each compound.

### V. Compositions

The present disclosure also concerns compositions comprising at least one disclosed compound or compounds according to any one of Formulas I-XIV, and at least one additional component. Such compositions include a paint, an ink, a dye, a glass, a plastic, an emulsion, a fabric, or a cosmetic preparation. Suitable additional components for use in paint, ink dye or emulsion products include, but are not limited to, binders, solvents, and additives such as catalysts, thickeners, stabilizers, emulsifiers, texturizers, adhesion promoters, UV stabilizers, flatteners (i.e., de-glossing agents), preservatives, and other additives known to those of ordinary skill in the art.

Suitable additional materials for use in glass products include, for example, network formers (e.g., oxides of silicon, boron, germanium) to form a highly crosslinked network of chemical bonds, modifiers (e.g., calcium, lead, lithium, sodium, potassium) that alter the network structure, intermediates (e.g., titanium, aluminum, zirconium, beryllium, magnesium, zinc) that can act as both network formers and modifiers, and combinations thereof.

Suitable additional materials for use in plastic products include, for example, dispersion aids (e.g., zinc stearate, calcium stearate, ethylene bis-steamide), plasticizers, flame retardants, internal mold release agents, slip agents, and combinations thereof.

When coloring a ceramic product, the material typically is added to a ceramic glaze composition. Other materials used in glazes include, for example, silica, metal oxides (e.g., sodium, potassium, calcium), alumina, opacifiers (e.g., tin oxide, zirconium oxide), and combinations thereof.

### VI. Examples

### Example 1

The colored thortveitite-based pigments were prepared via traditional solid state reactions. Stoichiometric amount of ACO₃ (A=Mg, Ca, Sr, Ba), M₂O₃ (M=Al, Ga, In, Mn, Fe, Cr, Sc, Y, La, Ce, Pr, Nd, Sm, Eu, Gd, Tb, Dy, Ho, Er, Tm, Yb, Lu), M′O₂ (M′=Si, Ge), M″O (M″=Ni, Mn, Cu, Zn, Fe), M′″₂O₅(M′″=V, P), Co₃O₄ were weighed, mixed, ground and pelletized. The resulting pellets were then heated to a suitable temperature range for a suitable time in air, and optionally with multiple heating periods and intermediate grinding. Ramp rates were 300° C./h. The specific heating conditions used for certain disclosed embodiments are provided in FIGS. 5-18.

The calcined powders were characterized by a Rigaku Miniflex X-ray diffractometer using Cu Ku radiation and a graphite monochromator on the diffracted beam. Diffuse reflectance spectra of powdered samples were obtained using a JASCO V-770 spectrophotometer up to 2500 nm. The data in the UV-vis range were transformed into absorbance using the Kubelka-Munk function. The L*a*b* color coordinates were measured by a Konica Minolta CM-700d spectrophotometer (Standard illuminant D65). The magnetic measurements for Zn₂₋ₓNiₓV₂O₇ (x=0.2 and 0.23) samples were performed using a Quantum Design MPMS instrument over a temperature range of 5 to 300 K.

Exemplary compounds made by the disclosed method are shown in Table 12, along with the reaction conditions and exemplary starting materials. A person of ordinary skill in the art understands how to adjust the amounts of the disclosed starting materials to produce alternative compositions.

TABLE 12

| | | Starting Materials | |
|---|---|---|---|
| Composition | Reaction Conditions | (to make 10 g of product) | |
| Zn₂V₂O₇ | 600-695° C., 12 hours | ZnO: | 4.72 g |
| | (4 heatings) | V₂O₅: | 5.28 g |
| Zn_{1.99}Mn_{0.01}V₂O₇ | 650° C., 12 hours (1 heating) | | |
| Zn_{1.98}Mn_{0.02}V₂O₇ | 650° C., 12 hours (1 heating) | ZnO: | 4.68 g |
| | | MnO: | 0.04 g |
| | | V₂O₅: | 5.28 g |
| Zn_{1.97}Mn_{0.03}V₂O₇ | 650° C., 12 hours (1 heating) | | |
| Zn_{1.96}Mn_{0.04}V₂O₇ | 650° C., 12 hours (1 heating) | | |
| Zn_{1.95}Mn_{0.05}V₂O₇ | 650° C., 12 hours (2 heatings) | | |
| Zn_{1.9}Mn_{0.1}V₂O₇ | 650° C., 12 hours (2 heatings) | ZnO: | 4.50 g |
| | | MnO: | 0.21 g |
| | | V₂O₅: | 5.29 g |
| Zn_{1.95}Ni_{0.05}V₂O₇ | 700° C., 6 hours (3 heatings) | | |
| Zn_{1.9}Ni_{0.1}V₂O₇ | 700-750° C., 12 hours | | |
| | (2 heatings) | | |
| Zn_{1.8}Ni_{0.2}V₂O₇ | 700-750° C., 12 hours | ZnO: | 4.27 g |
| | (4 heatings) | NiO: | 0.43 g |
| | | V₂O₅: | 5.30 g |
| Zn_{1.77}Ni_{0.23}V₂O₇ | 700-750° C., 12 hours | ZnO: | 4.20 g |
| | (2 heatings) | NiO: | 0.50 g |
| | | V₂O₅: | 5.30 g |
| Zn_{1.76}Ni_{0.24}V₂O₇ | 750° C., 12 hours (4 heatings) | | |
| Zn_{1.75}Ni_{0.25}V₂O₇ | 750-800° C., 12 hours | | |
| | (3 heatings) | | |
| Zn_{1.7}Ni_{0.3}V₂O₇ | 750-800° C., 12 hours | | |
| | (4 heatings) | | |
| Zn_{1.4}Ni_{0.6}V₂O₇ | 750-800° C., 12 hours | | |
| | (2 heatings) | | |
| Zn_{1.2}Ni_{0.8}V₂O₇ | 750-800° C., 12 hours | | |
| | (3 heatings) | | |
| ZnNiV₂O₇ | 750-800° C., 12 hours | | |
| | (3 heatings) | | |
| Zn_{0.8}Ni_{1.2}V₂O₇ | 750° C., 12 hours (2 heatings) | ZnO: | 1.94 g |
| | | NiO: | 2.66 g |
| | | V₂O₅: | 5.40 g |
| Zn_{0.6}Ni_{1.4}V₂O₇ | 750° C., 12 hours (2 heatings) | | |
| Zn_{0.4}Ni_{1.6}V₂O₇ | 700-750° C., 12 hours | | |
| | (2 heatings) | | |
| Zn_{0.2}Ni_{1.8}V₂O₇ | 700-750° C., 12 hours | | |
| | (2 heatings) | | |
| Ni₂V₂O₇ | 700-800° C., 12 hours | NiO: | 4.51 g |
| | (3 heatings) | V₂O₅: | 5.49 g |
| Zn_{1.98}Mn_{0.01}Mg_{0.01}V₂O₇ | 650-675° C., 12 hours | | |
| | (2 heatings) | | |
| Zn_{1.96}Mn_{0.02}Mg_{0.02}V₂O₇ | 650-675° C., 12 hours | ZnO: | 4.64 g |
| | (2 heatings) | MnO: | 0.04 g |
| | | MgO: | 0.02 g |
| | | V₂O₅: | 5.29 g |
| Zn_{1.94}Mn_{0.03}Mg_{0.03}V₂O₇ | 675-700° C., 12 hours | | |
| | (2 heatings) | | |
| Zn_{1.92}Mn_{0.04}Mg_{0.04}V₂O₇ | 700-750° C., 12 hours | | |
| | (2 heatings) | | |
| Zn_{1.96}Mn_{0.02}Ni_{0.02}V₂O₇ | 750° C., 12 hours (2 heatings) | ZnO: | 4.64 g |
| | | MnO: | 0.04 g |
| | | NiO: | 0.04 g |
| | | V₂O₅: | 5.28 g |
| Zn_{1.96}Mn_{0.02}Ni_{0.02}V₂O₇ | 750° C., 12 hours (2 heatings) | | |
| Zn_{1.94}Mn_{0.03}Ni_{0.03}V₂O₇ | 750° C., 12 hours (2 heatings) | | |
| Zn_{1.92}Mn_{0.04}Ni_{0.04}V₂O₇ | 750° C., 12 hours (2 heatings) | | |
| Zn_{1.9}Mn_{0.05}Ni_{0.05}V₂O₇ | 750° C., 12 hours (2 heatings) | | |
| Zn_{1.99}C_{00.01}V₂O₇ | 700° C., 12 hours (2 heatings) | | |
| Zn_{1.97}C_{00.03}V₂O₇ | 700° C., 12 hours (2 heatings) | | |
| Zn_{1.95}C_{00.05}V₂O₇ | 700° C., 12 hours (2 heatings) | ZnO: | 4.61 g |
| | | CoO: | 0.01 g |
| | | V₂O₅: | 5.28 g |
| Zn_{1.93}C_{00.}O₇V₂O₇ | 700° C., 12 hours (2 heatings) | | |
| Zn_{1.91}C_{00.09}V₂O₇ | 700° C., 12 hours (2 heatings) | | |
| Zn_{1.9}C_{00.1}V₂O₇ | 700° C., 12 hours (2 heatings) | ZnO: | 4.49 g |
| | | CoO: | 0.22 g |
| | | V₂O₅: | 5.29 g |
| In_{1.9}Zn_{0.1}Ge_{1.9}V_{0.1}O₇ | 850-1050° C., 12 hours | | |
| | (5 heatings) | | |
| In_{1.7}Zn_{0.3}Ge_{1.7}V_{0.3}O₇ | 850-950° C., 12 hours | | |
| | (3 heatings) | | |
| In_{1.5}Zn_{0.5}Ge_{1.5}V_{0.5}O₇ | 800-850° C., 12 hours | | |
| | (2 heatings) | | |
| InZnGeVO₇ | 800-850° C., 12 hours | In₂O₃: | 3.34 g |
| | (2 heatings) | ZnO: | 1.96 g |
| | | GeO₂: | 2.52 g |
| | | V₂O₅: | 2.18 g |
| In_{0.5}Zn_{1.5}Ge_{0.5}V_{1.5}O₇ | 800-850° C., 12 hours | | |
| | (2 heatings) | | |
| In_{0.3}Zn_{1.7}Ge_{0.3}V_{1.7}O₇ | 800-850° C., 12 hours | | |
| | (2 heatings) | | |
| In_{0.2}Zn_{1.8}Ge_{0.2}V_{1.8}O₇ | 800-850° C., 12 hours | In₂O₃: | 0.77 g |
| | (2 heatings) | ZnO: | 4.08 g |
| | | GeO₂: | 0.59 g |
| | | V₂O₅: | 4.56 |
| In_{0.1}Zn_{1.9}Ge_{0.1}V_{1.9}O₇ | 750-850° C., 12 hours | | |
| | (4 heatings) | | |
| In_{0.}O₇Zn_{1.93}Ge_{0.}O₇V_{1.93}O₇ | 750° C., 12 hours (3 heatings) | | |
| In_{0.06}Zn_{1.94}Ge_{0.06}V_{1.94}O₇ | 750° C., 12 hours (3 heatings) | | |
| In_{0.05}Zn_{1.95}Ge_{0.05}V_{1.95}O₇ | 750° C., 12 hours (3 heatings) | | |
| In_{0.02}Zn_{1.98}Ge_{0.02}V_{1.98}O₇ | 750° C., 12 hours (3 heatings) | In₂O₃: | 0.08 g |
| | | ZnO: | 4.66 g |
| | | GeO₂: | 0.06 g |
| | | V₂O₅: | 5.20 g |
| InZn_{0.9}Ni_{0.1}GeVO₇ | 850° C., 12 hours (2 heatings) | | |
| InZn_{0.7}Ni_{0.3}GeVO₇ | 850° C., 12 hours (2 heatings) | In₂O₃: | 3.36 g |
| | | ZnO: | 1.38 g |
| | | NiO: | 0.54 g |
| | | GeO₂: | 2.53 g |
| | | V₂O₅: | 2.19 g |
| InZn_{0.5}Ni_{0.5}GeVO₇ | 850-1000° C., 12 hours | | |
| | (4 heatings) | | |
| InZn_{0.3}Ni_{0.7}GeVO₇ | 850-1000° C., 12 hours | | |
| | (4 heatings) | | |
| InNiGeVO₇ | 850-1000° C., 12 hours | | |
| | (4 heatings) | | |
| In_{0.9}Mn_{0.1}ZnGeVO₇ | 800-850° C., 12 hours | | |
| | (2 heatings) | | |
| Zn_{1.67}Ni_{0.23}Mg_{0.1}V₂O₇ | 750° C., 12 hours (2 heatings) | ZnO: | 4.01 g |
| | | NiO: | 0.51 g |
| | | MgO: | 0.12 g |
| | | V₂O₅: | 5.36 g |
| Zn_{1.67}Ni_{0.23}Ca_{0.1}V₂O₇ | 750° C., 12 hours (2 heatings) | ZnO: | 3.99 g |
| | | NiO: | 0.50 g |
| | | CaO: | 0.17 g |
| | | V₂O₅: | 5.34 g |
| Zn_{1.67}Ni_{0.23}(NaAl)_{0.1}V₂O₇ | 750° C., 12 hours (2 heatings) | ZnO: | 3.98 g |
| | | NiO: | 0.50 g |
| | | Na₂CO₃: | 0.15 g |
| | | Al₂O₃: | 0.15 g |
| | | V₂O₅: | 5.33 g |
| Zn_{1.67}Ni_{0.23}(NaGa)_{0.1}V₂O₇ | 750° C., 12 hours (2 heatings) | | |
| Zn_{1.67}Ni_{0.23}(KAI)_{0.1}V₂O₇ | 750° C., 12 hours (2 heatings) | | |
| Zn_{1.67}Ni_{0.23}(KGa)_{0.1}V₂O₇ | 750° C., 12 hours (2 heatings) | | |
| Ni₂P₂O₇ | 750-1000° C., 6-12 hours | NiO: | 5.13 g |
| | (7 heatings) | (NH₄)₂PO₄: | 9.07 g |
| Zn_{1.77}Ni_{0.23}P₂O₇ | 750° C., 12 hours (2 heatings) | ZnO: | 4.75 g |
| | | NiO: | 0.57 g |
| | | (NH₄)₂PO₄: | 8.71 g |
| Zn_{1.77}Ni_{0.23}V_{1.8}P_{0.2}O₇ | 750° C., 12 hours (2 heatings) | ZnO: | 4.25 g |
| | | NiO: | 0.51 g |
| | | V₂O₅: | 4.82 g |
| | | (NH₄)₂PO₄: | 0.78 g |
| Zn_{1.67}Ni_{0.23}Mg_{0.1}V_{1.8}P_{0.2}O₇ | 750° C., 12 hours (2 heatings) | | |
| Zn_{1.67}Ni_{0.23}Ca_{0.1}V_{1.8}P_{0.2}O₇ | 750° C., 12 hours (2 heatings) | ZnO: | 4.04g |
| | | NiO: | 0.51 g |
| | | CaO: | 0.16 g |
| | | V₂O₅: | 4.86 g |
| | | (NH₄)₂PO₄: | 0.78 g |
| Zn_{1.67}Ni_{0.23}(NaAl)_{0.1}V_{1.8}P_{0.2}O₇ | 750° C., 12 hours (2 heatings) | | |
| Zn_{1.67}Ni_{0.23}(NaGa)_{0.1}V_{1.8}P_{0.2}O₇ | 750° C., 12 hours (2 heatings) | | |
| Zn_{1.67}Ni_{0.23}(KAI)_{0.1}V_{1.8}P_{0.2}O₇ | 750° C., 12 hours (2 heatings) | | |
| Zn_{1.67}Ni_{0.23}(KGa)_{0.1}V_{1.8}P_{0.2}O₇ | 750° C., 12 hours (2 heatings) | ZnO: | 3.96 g |
| | | NiO: | 0.50 g |
| | | K₂CO₃: | 0.20 g |
| | | Ga₂O₃: | 0.27 g |
| | | V₂O₅: | 4.77 g |
| | | (NH₄)₂PO₄: | 0.77 g |
| Zn_{1.9}Cu_{0.1}V₂O₇ | 700° C., 12 hours (2 heatings) | ZnO: | |
| | | CuO: | |
| | | V₂O₅: | |
| Zn_{1.8}Cu_{0.1}Ni_{0.1}V₂O₇ | 700° C., 12 hours (2 heatings) | ZnO: | 4.26 g |
| | | CuO: | 0.24 g |
| | | NiO: | 0.22 g |
| | | V₂O₅: | 5.29 g |
| Zn_{1.8}Cu_{0.1}Mn_{0.1}V₂O₇ | 700° C., 12 hours (2 heatings) | | |
| Zn_{1.8}Cu_{0.1}Mg_{0.1}V₂O₇ | 700° C., 12 hours (2 heatings) | ZnO: | 4.30 g |
| | | CuO: | 0.23 g |
| | | MgO: | 0.12 g |
| | | V₂O₅: | 5.34 g |
| Zn_{1.8}Cu_{0.1}Ca_{0.1}V₂O₇ | 700° C., 12 hours (2 heatings) | ZnO: | 4.28 g |
| | | CuO: | 0.23 g |
| | | CaO: | 0.17 g |
| | | V₂O₅: | 5.31 g |
| Cu₂P₂O₇ | 700-1000° C., 6-12 hours | CuO: | 5.28 g |
| | (4 heatings) | (NH₄)₂PO₄: | 8.77 g |
| Zn_{1.9}Cu_{0.1}P₂O₇ | 700° C., 12 hours (2 heatings) | | |
| Zn_{1.9}Cu_{0.1}V_{1.8}P_{0.2}O₇ | 700° C., 12 hours (2 heatings) | ZnO: | 4.54 g |
| | | CuO: | 0.23 g |
| | | V₂O₅: | 4.81 g |
| | | (NH₄)₂PO₄: | 0.77 g |
| Zn_{1.88}Mn_{0.02}Ni_{0.1}V₂O₇ | 700° C., 12 hours (2 heatings) | | |
| Zn_{1.88}Mn_{0.02}Mg_{0.1}V₂O₇ | 700° C., 12 hours (2 heatings) | | |
| Zn_{1.88}Mn_{0.02}Ca_{0.1}V₂O₇ | 700° C., 12 hours (2 heatings) | ZnO: | 4.48 g |
| | | MnO: | 0.04 g |
| | | CaO: | 0.17 g |
| | | V₂O₅: | 5.32 g |
| Mn₂P₂O₇ | 700-1000° C., 6-12 hours | | |
| | (3 heatings) | | |
| Zn_{1.98}Mn_{0.02}P₂O₇ | 700-1000° C., 6-12 hours | | |
| | (3 heatings) | | |
| Zn_{1.98}Mn_{0.02}V_{1.8}P_{0.2}O₇ | 700° C., 12 hours (2 heatings) | ZnO: | 4.73 g |
| | | MnO: | 0.05 g |
| | | V₂O₅: | 4.81 g |
| | | (NH₄)₂PO₄: | 0.78 g |
| Zn_{1.88}Mn_{0.02}Ni_{0.1}V_{1.8}P_{0.2}O₇ | 700° C., 12 hours (2 heatings) | ZnO: | 4.51 g |
| | | MnO: | 0.04 g |
| | | NiO: | 0.22 g |
| | | V₂O₅: | 4.82 g |
| | | (NH₄)₂PO₄: | 0.78 g |
| Zn_{1.88}Mn_{0.02}Mg_{0.1}V_{1.8}P_{0.2}O₇ | 700° C., 12 hours (2 heatings) | | |
| Zn_{1.88}Mn_{0.02}Ca_{0.1}V_{1.8}P_{0.2}O₇ | 700° C., 12 hours (2 heatings) | ZnO: | 4.53 g |
| | | MnO: | 0.04 g |
| | | CaO: | 0.17 g |
| | | V₂O₅: | 4.84 g |
| | | (NH₄)₂PO₄: | 0.78 g |
| Zn_{1.9}Mn_{0.1}VPO₇ | 700-1000° C., 6-12 hours | | |
| | (3 heatings) | | |
| C₀₂P₂O₇ | 750-850° C., 6-12 hours | CoO: | 5.14 g |
| | (3 heatings) | (NH₄)₂PO₄: | 9.05 g |
| Zn_{1.9}C_{00.1}P₂O₇ | 750° C., 12 hours (2 heatings) | ZnO: | 5.09 g |
| | | CoO: | 0.25 g |
| | | (NH₄)₂PO₄: | 8.69 g |
| Zn_{1.9}C_{00.1}V_{1.8}P_{0.2}O₇ | 700-750° C., 12 hours | ZnO: | 4.55 g |
| | | CoO: | 0.22 g |
| | (2 heatings) | V₂O₅: | 4.82 g |
| | | (NH₄)₂PO₄: | 0.78 g |
| Mg₂V₂O₇ | 700° C., 12 hours (2 heatings) | MgO: | 3.07 g |
| | | V₂O₅: | 6.93 g |
| Mg_{1.8}Ni_{0.2}V₂O₇ | 700° C., 12 hours (2 heatings) | MgO: | 2.69 g |
| | | NiO: | 0.56 g |
| | | V₂O₅: | 6.75 g |
| Mg_{1.8}Mn_{0.2}V₂O₇ | 700° C., 12 hours (2 heatings) | MgO: | 2.70 g |
| | | MnO: | 0.53 g |
| | | V₂O₅: | 6.77 g |
| Mg₂VPO₇ | 700-1000° C., 6-12 hours | | |
| | (4 heatings) | | |
| InZnSiVO₇ | 900-950° C., 6 hours | | |
| | (2 heatings) | | |
| InZn_{0.9}Ni_{0.1}SiVO₇ | 900-950° C., 6 hours | In₂O₃: | 3.75 g |
| | (2 heatings) | ZnO: | 1.98 g |
| | | NiO: | 0.20 g |
| | | SiO₂: | 1.62 g |
| | | V₂O₅: | 2.45 g |
| InZnGePO₇ | 850-1000° C., 6 hours | | |
| | (4 heatings) | | |
| InZn_{0.9}Ni_{0.1}GePO₇ | 850-1000° C., 6 hours | In₂O₃: | 3.81 g |
| | (4 heatings) | ZnO: | 1.85 g |
| | | NiO: | 0.19 g |
| | | GeO₂: | 2.65 g |
| | | (NH₄)₂PO₄: | 3.34 g |
| InZnSiPO₇ | 900-1000 C. (3 heatings) | | |
| InZn_{0.9}Ni_{0.1}SiPO₇ | 900-1000 C. (3 heatings) | In₂O₃: | 3.95 g |
| | | ZnO: | 2.09 g |
| | | NiO: | 0.21 g |
| | | SiO₂: | 0.17 g |
| | | (NH₄)₂PO₄: | 3.77 g |
| InZn_{0.9}Ni_{0.1}GeV_{0.8}P_{0.2}O₇ | 750-900 C. 6 hours | | |
| | (4 heatings) | | |
| InZn_{0.9}Ni_{0.1}SiV_{0.8}P_{0.2}O₇ | 750-900 C. 6 hours | In₂O₃: | 3.77 g |
| | (4 heatings) | ZnO: | 2.00 g |
| | | NiO: | 0.20 g |
| | | SiO₂: | 1.64 g |
| | | V₂O₅: | 1.98 g |
| | | (NH₄)₂PO₄: | 0.71 g |
| Ni_{1.98}Mn_{0.02}V₂O₇ | 800° C., 6 hours (3 heatings) | | |
| Zn_{1.9}Mn_{0.1}V_{1.8}P_{0.2}O₇ | 750-850° C., 6-12 hours | | |
| | (4 heatings) | | |
| Zn_{1.9}Mn_{0.1}V_{1.5}P_{0.5}O₇ | 750-850° C., 6-12 hours | | |
| | (4 heatings) | | |
| Zn_{1.5}Mn_{0.5}V_{1.5}P_{0.5}O₇ | 750-850° C., 6-12 hours | | |
| | (4 heatings) | | |
| Zn_{1.9}Fe_{0.1}V_{1.9}Ge_{0.1}O₇ | 700-850° C., 6 hours | | |
| | (4 heatings) | | |
| Zn_{1.9}Fe_{0.1}V_{1.9}Si_{0.1}O₇ | 700-850° C., 6 hours | ZnO: | 4.53 g |
| | (4 heatings) | Fe₂O₃: | 0.23 g |
| | | V₂O₅: | 5.06 g |
| | | SiO₂: | 0.18 g |
| Zn_{1.9}Cr_{0.1}V_{1.9}Ge_{0.1}O₇ | 700-850° C., 6 hours | | |
| | (4 heatings) | | |
| Zn_{1.9}Cr_{0.1}V_{1.9}Si_{0.1}O₇ | 700-850° C., 6 hours | ZnO: | 4.53 g |
| | (4 heatings) | Cr₂O₃: | 0.22 g |
| | | V₂O₅: | 5.07 g |
| | | SiO₂: | 0.18 g |
| Zn_{1.9}Sc_{0.1}V_{1.9}Si_{0.1}O₇ | 700-800° C., 6 hours | | |
| | (3 heatings) | | |
| Zn_{1.8}Sc_{0.1}Ni_{0.1}V_{1.9}Si_{0.1}O₇ | 700-800° C., 6 hours | ZnO: | 4.31 g |
| | (3 heatings) | SC₂O₃: | 0.20 g |
| | | NiO: | 0.22 g |
| | | V₂O₅: | 5.09 g |
| | | SiO₂: | 0.18 g |
| Zn_{1.9}Sc_{0.1}V_{1.9}Ge_{0.1}O₇ | 700-800° C., 6 hours | | |
| | (3 heatings) | | |
| Zn_{1.8}Sc_{0.1}Ni_{0.1}V_{1.9}Ge_{0.1}O₇ | 700-800° C., 6 hours | ZnO: | 4.26 g |
| | (3 heatings) | Sc₂O₃: | 0.20 g |
| | | NiO: | 0.22 g |
| | | V₂O₅: | 5.02 g |
| | | GeO₂: | 0.30 g |
| Zn_{1.9}Y_{0.1}V_{1.9}Si_{0.1}O₇ | 750-800° C., 6 hours | | |
| | (2 heatings) | | |
| Zn_{1.8}Y_{0.1}Ni_{0.1}V_{1.9}Si_{0.1}O₇ | 750-800° C., 6 hours | ZnO: | 4.26 g |
| | (2 heatings) | Y₂O₃: | 0.33 g |
| | | NiO: | 0.22 g |
| | | V₂O₅: | 5.02 g |
| | | SiO₂: | 0.18 g |
| Zn_{1.9}Y_{0.1}V_{1.9}Ge_{0.1}O₇ | 750-800° C., 6 hours | | |
| | (2 heatings) | | |
| Zn_{1.8}Y_{0.1}Ni_{0.1}V_{1.9}Ge_{0.1}O₇ | 750-800° C., 6 hours | ZnO: | 4.20 g |
| | (2 heatings) | Y₂O₃: | 0.32 g |
| | | NiO: | 0.22 g |
| | | V₂O₅: | 4.96 g |
| | | GeO₂: | 0.30 g |
| Zn_{1.9}La_{0.1}V_{1.9}Si_{0.1}O₇ | 750-800° C., 6 hours | | |
| | (2 heatings) | | |
| Zn_{1.8}La_{0.1}Ni_{0.1}V_{1.9}Si_{0.1}O₇ | 750-800° C., 6 hours | ZnO: | 4.20 g |
| | (2 heatings) | La₂O₃: | 0.47 g |
| | | NiO: | 0.21 g |
| | | V₂O₅: | 4.95 g |
| | | SiO₂: | 0.17 g |
| Zn_{1.9}La_{0.1}V_{1.9}Ge_{0.1}O₇ | 750-800° C., 6 hours | | |
| | (2 heatings) | | |
| Zn_{1.8}La_{0.1}Ni_{0.1}V_{1.9}Ge_{0.1}O₇ | 750-800° C., 6 hours | ZnO: | 4.14 g |
| | (2 heatings) | La₂O₃: | 0.46 g |
| | | NiO: | 0.21 g |
| | | V₂O₅: | 4.89 g |
| | | GeO₂: | 0.30 g |

### Results and Discussion

The results of materials characterization are demonstrated here using the following exemplary solid solution system: Zn₂₋ₓNiₓV₂O₇ (0≤x≤0.3).

Colors of orange powders at selected compositions are shown in FIG. 19. Powders of various colors with different compositions are shown in FIGS. 5-18.

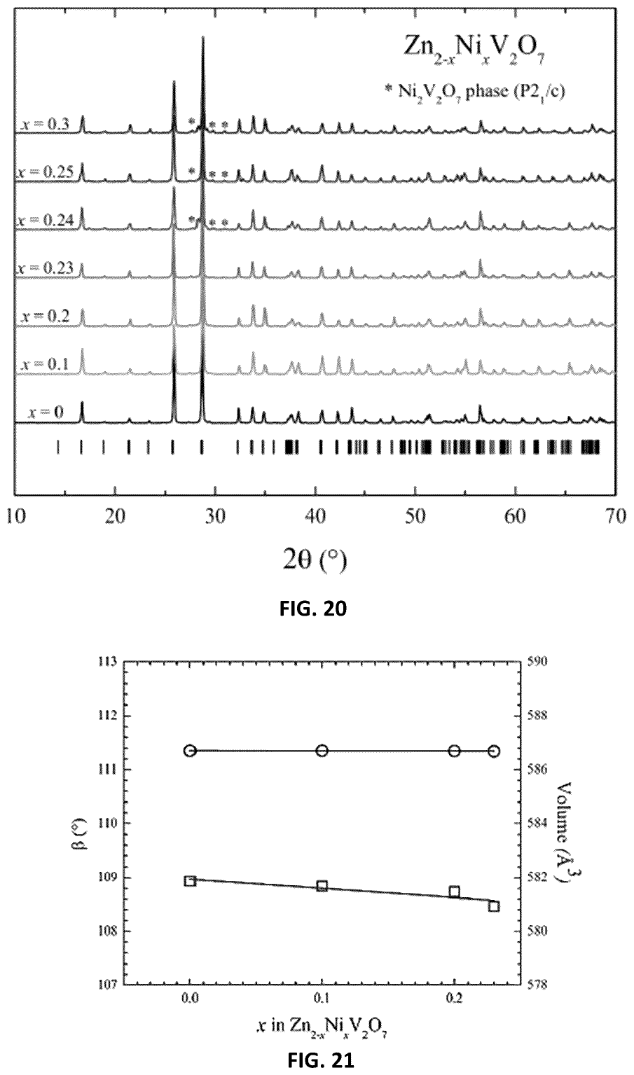

X-ray diffraction patterns of solid solutions Zn₂₋ₓNiₓV₂O₇ (0≤x≤0.3) are shown in FIG. 20. The lattice parameters of the unit cells calculated by whole pattern fitting are shown in FIG. 21. The decrease of the unit cell volume is consistent with the substitution of larger Zn²⁺ ions with smaller Ni²⁺.

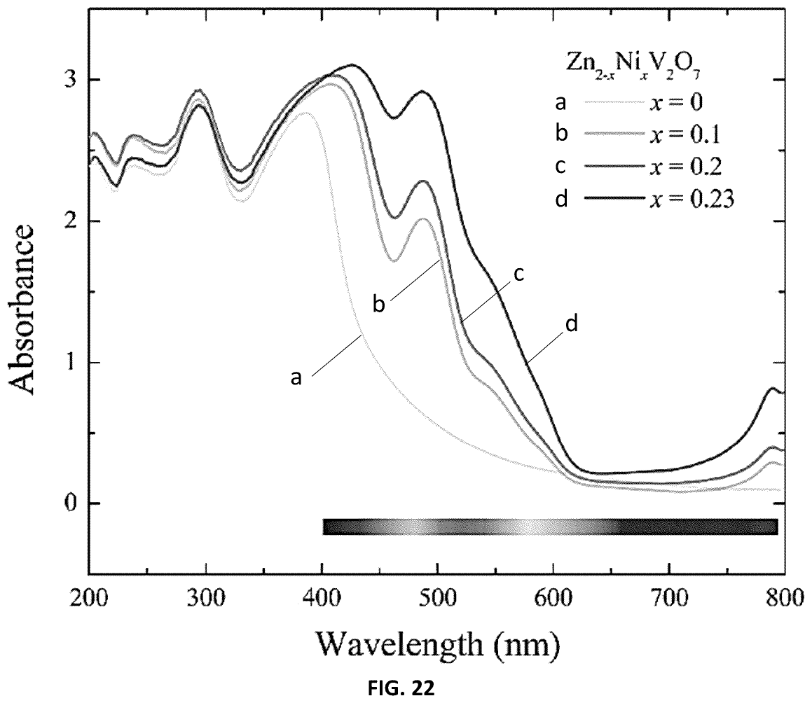

Diffuse reflectance spectra for the Zn₂₋ₓNiₓV₂O₇ (0 5×5 0.3) solid solutions are shown in FIG. 22. Strong absorption in the blue/green spectral region combined with absorption in higher energy range is responsible for the observed bright orange/red color. In pure Zn₂V₂O₇, almost no absorption occurs in the entire visible range except weak absorption near the purple spectral region, resulting in the pale yellow color. With increasing Ni content x, the intensity of the absorption peak near 480 nm increases, consistent with the gradual darkening of the samples toward intense orange/red. The inventors are unaware of any precedent for an intense orange/red color arising from Ni²⁺ in oxides.

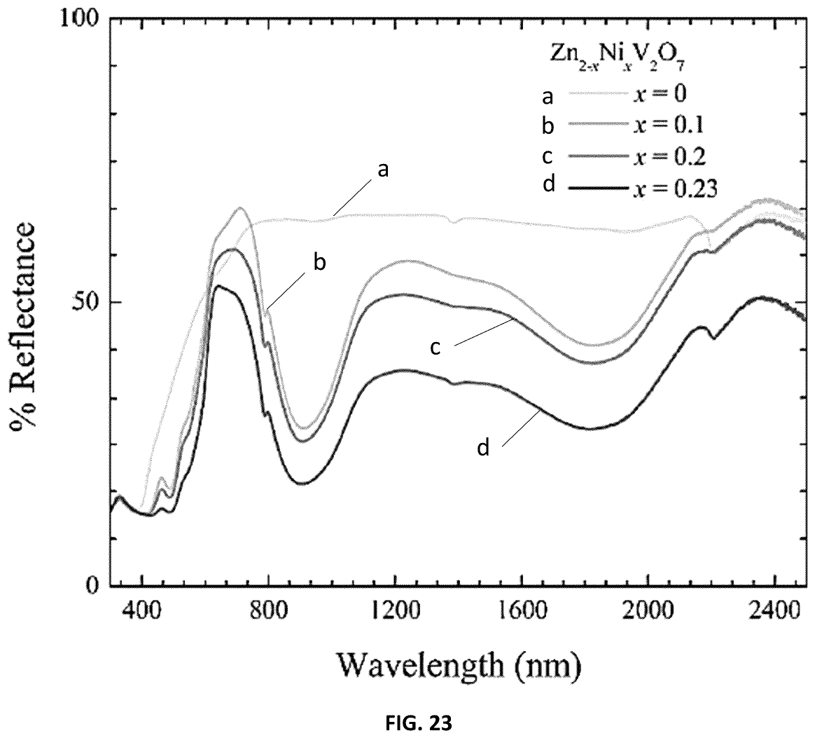

NIR reflectance spectra for the Zn₂₋ₓNiₓV₂O₇ (0≤x≤0.3) solid solutions are shown in FIG. 23. The NIR reflectance decreases with increasing Ni content.

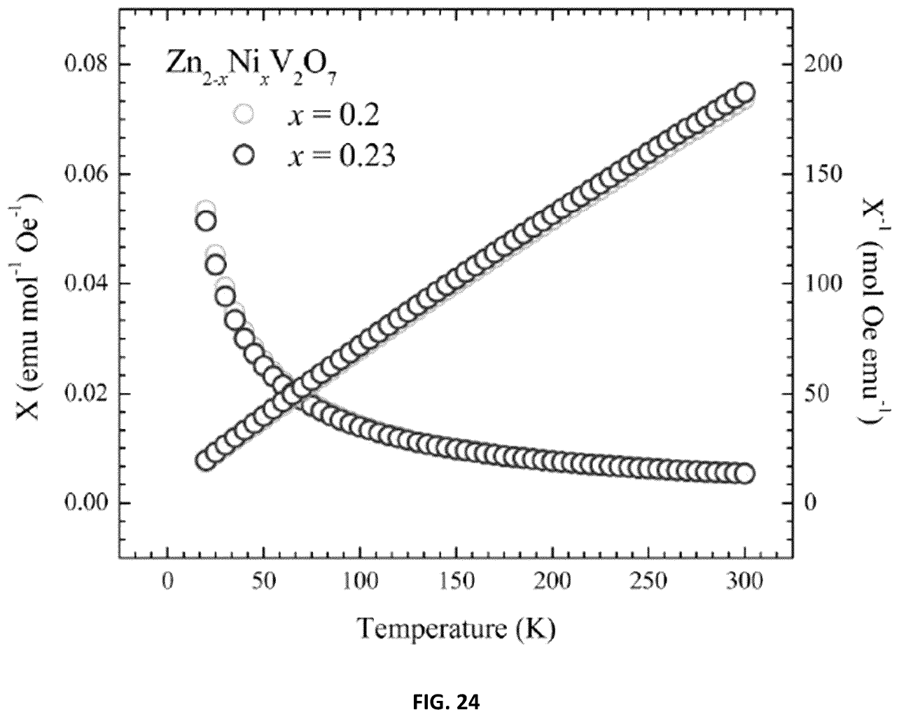

Plots of magnetic susceptibility are shown in FIG. 24. The Curie and Weiss Constants were derived from the slope and intercept of the straight line region of 1/χ versus T. The magnetic susceptibility data for Zn₂₋ₓNiₓV₂O₇ (x=0.2, 0.23) suggest a nearly paramagnetic behavior. The experimental moments are in reasonable agreement with the moments expected from high-spin Ni²⁺.

### Example 2

### Acid Test

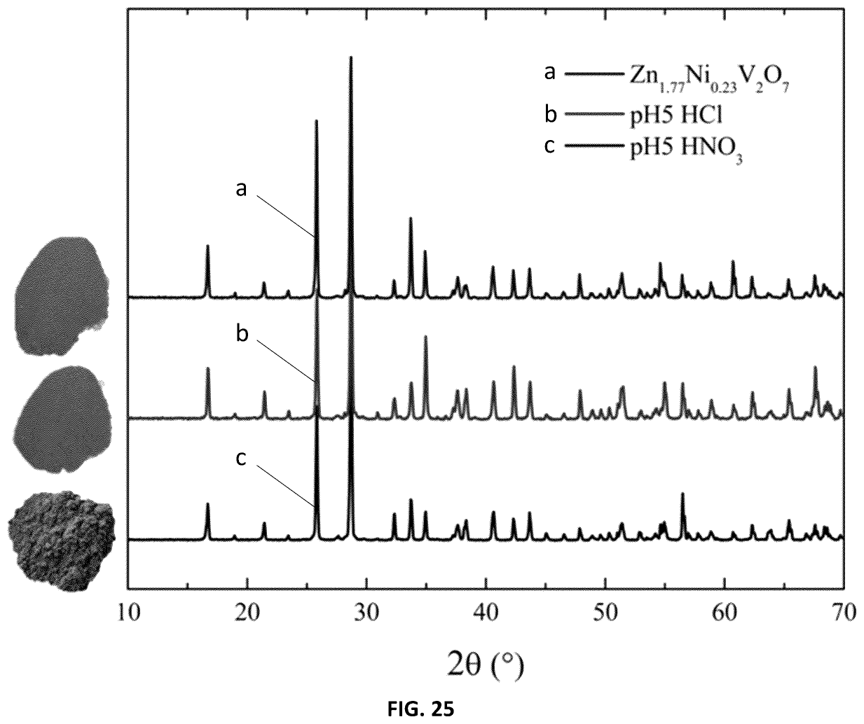

Compounds were tested to determine if the color was affected by exposure to acid at a pH range similar to normal rain. Normal rain has a pH of about 5.6, so the compounds were exposed to two dilute acid samples, HCl and HNO₃, at pH=5. The results are shown below, before and after the acid tests. The results indicate that color change due to acid exposure is very slight, if present at all, based on the L*, a* and b* values (Table 12). Additionally, the X-ray diffraction patterns indicate that any crystal structure change also is very small, if at all (FIG. 25).

TABLE 12

| Compound | L* | a* | b* |
|---|---|---|---|
| Zn_{1.77}Ni_{0.23}V₂O₇ | 40.38 | 26.31 | 29.73 |
| pH5 HCl | 38.90 | 25.52 | 28.83 |
| pH5 HNO₃ | 37.60 | 25.95 | 28.40 |

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A compound having a structure according to one of Formulas I-XIV:
Formula I Zn₂₋ₓNiₓV₂O₇, where x is from greater than 0.2 to 0.8, or x is from 1.2 to 1.8;
Formula II Zn₂₋₂ₓMnₓMₓV₂O₇, where x is from greater than zero to 0.05, and M is Mg or Ni;
Formula III In₂₋ₓZnₓGe₂₋ₓVₓO₇, where x is from greater than zero to less than 2;
Formula IV InZn₁₋ₓNiₓGeVO₇, where x is from greater than 0 to 1;
Formula V In₁₋ₓMnₓZnGeVO₇, where x is from greater than 0 to less than 1;
Formula VI Zn_{1.77-x}Ni_{0.23}MₓV_{2-y}P_{y}O₇, where x is from zero to 0.1, y is from zero to 2, and M is Mg, Ca, (NaAl), (NaGa), (KAl), or (KGa);
Formula VII Zn_{1.8}Cu_{0.1}M_{0.1}V₂O₇, where M is Ni, Mn, Mg, or Ca;
Formula VIII Zn_{1.9}Cu_{0.1}VₓP₂₋ₓO₇, where x is from zero to 1.8;
Formula IX Zn_{2-x-y}MnₓM_{y}V_{2-z}P_{z}O₇, where M is Ni, Mg, or Ca, x is from greater than zero to 0.5, y is from zero to 0.1, and z is from zero to 1;
Formula X Mg₂₋ₓMₓV_{2-y}P_{y}O₇, where M is Ni or Mn, x is from zero to 0.2, and y is from zero to 1;
Formula XI InZn₁₋ₓNiₓMV_{1-y}P_{y}O₇, where M is Si or Ge, x is from zero to 0.3, and y is from zero to 1;
Formula XII Zn_{2-x-y}MₓNi_{y}V₂₋ₓAₓO₇, where M is Fe, Cr, Sc, Y, or La, A is Ge, or Si, x is from greater than zero to 0.1, and y is from zero to 0.1;
Formula XIII Zn₁₋ₓCoₓV_{1.8}P_{0.2}O₇, where x is from greater than zero to less than 1; or
Formula XIV Ni₁₋ₓMnₓV₂O₇, where x is from greater than zero to less than 1.

2. The compound of claim 1 having a structure according to Formula I
Zn₂₋ₓNiₓV₂O₇ Formula I
wherein:
x is from greater than 0.2 to 0.8; or
x is from 1.2 to 1.8.

3. The compound of claim 2, wherein x is from greater than 0.2 to less than 0.5.

4. The compound of claim 2, wherein the compound has L*a*b* values of L* from 34 to 60, a* from 10 to 27, and b* from 19 to 60.

5. The compound of claim 4, wherein x is from greater than 0.2 to 0.8 and the compound has L*a*b* values of L* from 34 to 51, a* from 17 to 27, and b* from 19 to 49.

6. The compound of claim 4, wherein x is from 1.2 to 1.8 and the compound has L*a*b* values of L* from 51 to 60, a* from 10 to 14, and b* from 48 to 60.

7. The compound of claim 2, wherein the compound is selected from Zn_{1.77}Ni_{0.23}V₂O₇, Zn_{1.76}Ni_{0.24}V₂O₇, Zn_{1.75}Ni_{0.25}V₂O₇, Zn_{1.7}Ni_{0.3}V₂O₇, Zn_{1.4}Ni_{0.6}V₂O₇, Zn_{1.2}Ni_{0.8}V₂O₇, Zn_{0.8}Ni_{1.2}V₂O₇, Zn_{0.6}Ni_{1.4}V₂O₇, Zn_{0.4}Ni_{1.6}V₂O₇, or Zn_{0.2}Ni_{1.8}V₂O₇.

8. A composition, comprising:
a compound of claim 2; and
at least one additional component.

9. The composition of claim 8, wherein the composition is a paint, an ink, a dye, a glass, a plastic, an emulsion, a fabric, or a cosmetic preparation.

10. The composition of claim 8, wherein the at least one additional component is a binder, a solvent, a catalyst, a thickener, a stabilizer, an emulsifier, a texturizer, an adhesion promoter, a UV stabilizer, a flattener, a preservative, a polymer, a dispersion aid, a plasticizer, a flame retardant, an oxide of a metal, or any combination thereof.

11. The composition of claim 8, wherein the composition is a glass, and the at least one additional component is a metal oxide.

12. The composition of claim 8, further comprising at least one additional compound according to any one of Formulas I-XIV:
Formula II Zn₂₋₂ₓMnₓMₓV₂O₇, where x is from greater than zero to 0.05, and M is Mg or Ni;
Formula III In₂₋ₓZnₓGe₂₋ₓVₓO₇, where x is from greater than zero to less than 2;
Formula IV InZn₁₋ₓNiₓGeVO₇, where x is from greater than 0 to 1;
Formula V In₁₋ₓMnₓZnGeVO₇, where x is from greater than 0 to less than 1;
Formula VI Zn_{1.77-x}Ni_{0.23}MₓV_{2-y}P_{y}O₇, where x is from zero to 0.1, y is from zero to 2, and M is Mg, Ca, (NaAl), (NaGa), (KAl), or (KGa);
Formula VII Zn_{1.8}Cu_{0.1}M_{0.1}V₂O₇, where M is Ni, Mn, Mg, or Ca;
Formula VIII Zn_{1.9}Cu_{0.1}VₓP₂₋ₓO₇, where x is from zero to 1.8;
Formula IX Zn_{2-x-y}MnₓM_{y}V_{2-z}P_{z}O₇, where M is Ni, Mg, or Ca, x is from greater than zero to 0.5, y is from zero to 0.1, and z is from zero to 1;
Formula X Mg₂₋ₓMₓV_{2-y}P_{y}O₇, where M is Ni or Mn, x is from zero to 0.2, and y is from zero to 1;
Formula XI InZn₁₋ₓNiₓMV_{1-y}P_{y}O₇, where M is Si or Ge, x is from zero to 0.3, and y is from zero to 1;
Formula XII Zn_{2-x-y}MₓNi_{y}V₂₋ₓAₓO₇, where M is Fe, Cr, Sc, Y, or La, A is Ge, or Si, x is from greater than zero to 0.1, and y is from zero to 0.1;
Formula XIII Zn₁₋ₓCoₓV_{1.8}P_{0.2}O₇, where x is from greater than zero to less than 1; or
Formula XIV Ni₁₋ₓMnₓV₂O₇, where x is from greater than zero to less than 1.

13. A method for making a compound of claim 2, the method comprising:
selecting metals desired in the compound;
providing reactants comprising the selected metals;
combining the reactants in stoichiometric amounts to achieve a desired final ratio of the selected metals in the compound; and
heating the combination of reactants at an effective temperature for an effective period of time to form the compound.

14. The method of claim 13, wherein the effective temperature is from 600° C. to 1050° C.

15. The method of claim 13, wherein the period of time is from 6 hours to 12 hours.

16. The method of claim 13, wherein heating the combination of reactants comprises heating for a first time period of from 6 hours to 12 hours, grinding the reaction the reaction mixture and reheating for a second time period of from 6 hours to 12 hours.
